(19) United States
(12) Patent Application Publication
(10) Pub. No.: US 2003/0022036 A1
(43) Pub. Date: Jan. 30, 2003

(54) Fuel cell controller self inspection

(75) Inventor: Robert Kenneth Parr, Calgary (CA)

Correspondence Address: SEED INTELLECTUAL PROPERTY LAW GROUP PLLC, 701 FIFTH AVE, SUITE 6300, SEATTLE, WA, 98104-7092, US

(73) Assignee: Ballard Power Systems Inc., Burnaby, BC (CA)

(21) Appl. No.: 09/916,117

(22) Filed: Jul. 25, 2001

(51) Int. Cl. H01M 8/04

(52) U.S. Cl. 429/22; 429/13

(57) ABSTRACT

A microcontroller in a fuel cell system performs at least a portion of a self-test of general registers while the system is in a starting state, and at least a portion of a self-test while in a running state. The self-test includes setting the general purpose registers to a first bit pattern, complementing the bits of one of the general registers, copying the complemented general register to a special register, determining if each bit in special register was complemented, and producing a notification. The microcontroller also verifies that the other general registers are not affected. The microcontroller again complements the previously complemented general purpose register, copies the complemented general register to the special register, determines if the special register matches the predefined pattern, and produces a notification. The microcontroller again verifies that the other general purpose registers were not affected. The process is repeated for the complement of the first bit pattern, and for each general register.

### BACKGROUND OF THE INVENTION

1. Technical Field

The present invention relates to self inspection of monitoring and control systems, and in particular to self inspection of fuel cell monitoring and control systems.

2. Description of the Related Art

Electrochemical fuel cells convert fuel and oxidant to electricity. Solid polymer electrochemical fuel cells generally employ a membrane electrode assembly (“MEA”) which comprises an ion exchange membrane or solid polymer electrolyte disposed between two electrodes typically comprising a layer of porous, electrically conductive sheet material, such as carbon fiber paper or carbon cloth. The MEA contains a layer of catalyst, typically in the form of finely comminuted platinum, at each membrane/electrode interface to induce the desired electrochemical reaction. In operation the electrodes are electrically coupled to provide a circuit for conducting electrons between the electrodes through an external circuit. Typically, a number of MEAs are serially coupled electrically to form a fuel cell stack having a desired power output.

In typical fuel cells, the MEA is disposed between two electrically conductive fluid flow field plates or separator plates. Fluid flow field plates have at least one flow passage formed in at least one of the major planar surfaces thereof. The flow passages direct the fuel and oxidant to the respective electrodes, namely, the anode on the fuel side and the cathode on the oxidant side. The fluid flow field plates act as current collectors, provide support for the electrodes, provide access channels for the fuel and oxidant to the respective anode and cathode surfaces, and provide channels for the removal of reaction products, such as water, formed during operation of the cell.

Due to their zero- or low-emission nature, and ability to operate using renewable fuels, the use of fuel cells as primary and/or backup power supplies is likely to become increasingly prevalent. For example, a fuel cell stack can serve as an uninterruptible power supply for computer, medical, or refrigeration equipment in a home, office, or commercial environment. Other uses are of course possible

### SUMMARY OF THE INVENTION

Where operation of a fuel cell system is principally controlled by a microcontroller or microprocessor in an electronic control system, the operation or performance of the microcontroller or microprocessor should be monitored and evaluated to ensure the proper operation of the fuel cell system. For example, the operation of the various registers of the microcontroller or microprocessor should be periodically checked.

A fuel cell system includes a fuel cell stack, at least one sensor proximate the fuel cell stack to detect an operating parameter of the fuel cell stack, at least one actuator, and a microcontroller coupled to receive signals from the sensor and to provide signals to the actuator. In a first aspect, the microcontroller performs a self-test by: setting a set of bits in a number of general registers of the microcontroller to a predefined pattern, complementing the set of bits of one of the general registers, copying the set of bits from one of the general registers to a special register of the microcontroller such as a status register, determining if each bit in the set of bits copied to the special register was complemented, and producing a notification signal based on the determination. The microcontroller may additionally perform the self-test by: for each general register other than the one general register, copying the set of bits from the other of the general register to the special register; determining if each bit in the set of bits copied to the special register from the other general register matches the corresponding bit in the predefined pattern, and producing a notification signal based on the determination. The microcontroller may further perform the self-test by: complementing the previously complemented set of bits in the one of the general registers, copying the set of bits from the one of the general registers to the special register, determining if each bit in the set of bits copied to the special register matches the predefined pattern. Additionally, the microcontroller may further perform the self-test by: for each of the other of the general registers, copying the set of bits from the other general register to the special register, and determining if each bit in the set of bits copied to the special register from the other general register matches the corresponding bit in the predefined pattern. The predefined pattern may alternate the value or setting of successive bits. The microcontroller may be configured to test each of the general registers of the microcontroller in a similar fashion.

In another aspect, a controller for controlling an operation of a fuel cell system is configured to: perform at least one self-test of the controller while the fuel cell system is in a starting state prior to operation of the fuel cell system, and perform at least one self-test with a controller while the fuel cell system is in a running state during operation of the fuel cell system.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, have been selected solely for ease of recognition in the drawings.

FIG. 1 is an isometric, partially exploded, view of a fuel cell system including a fuel cell stack and controlling electronics including a fuel cell monitoring and control system.

FIG. 2 is a schematic diagram representing fuel flow through a cascaded fuel cell stack of the fuel cell system of FIG. 1.

FIG. 3 is a schematic diagram of a portion of the fuel cell monitoring and control system of FIG. 1.

FIG. 4 is a schematic diagram of an additional portion of the fuel cell monitoring and control system of FIG. 3, including a fuel cell microcontroller selectively coupled between the fuel cell stack and a battery.

FIG. 5 is a top, right isometric view of a structural arrangement of various components of the fuel cell system of FIG. 1.

FIG. 6 is a top, right isometric view of the structural arrangement of various components of the fuel cell system of FIG. 5 with a cover removed.

FIG. 7 is top, left isometric view of the structural arrangement of various components of the fuel cell system of FIG. 5.

FIG. 8 is a top, right isometric view of a pressure regulator portion of the fuel cell system of FIG. 5.

FIG. 9 is a high-level flow diagram of a method of initializing a register test for a microcontroller self-check.

FIG. 10 is a flow diagram of a method of performing a register test for a microcontroller self-check.

FIGS. 11A and 11B are a flow diagram showing a method of testing an Nth general purpose register N, as one of the acts of the register test of FIG. 10.

FIG. 12 is a flow diagram showing a method of verifying that an Nth general register contains the hexadecimal value 0xAA and all other general registers contain the hexadecimal value 0x55, as one of the acts of the method of FIG. 11.

FIG. 13 is a flow diagram showing a method of verifying that an Nth general register contains the hexadecimal value 0x55 and all other general registers contain the hexadecimal value 0xAA, as one of the acts of the method of FIG. 11.

FIG. 14 is a flow diagram showing a method of verifying that all general purpose registers contain the hexadecimal value 0x55, as one of the acts of the method of FIG. 11.

FIG. 15 is a flow diagram showing a method of verifying that all general purpose registers contain the hexadecimal value 0xAA, as one of the acts of the method of FIG. 11.

FIG. 16 is a flow diagram showing a method of verifying that an Nth general purpose register contains the hexadecimal value 0x55, as one of the acts of the methods of FIGS. 13 and 14.

FIG. 17 is a flow diagram showing a method of verifying that an Nth general purpose register contains the hexadecimal value 0xAA, as one of the acts of the methods of FIGS. 12 and 15.

FIG. 18 is a flow diagram showing a method of performing a microcontroller self-check in relationship to an operational state of the fuel cell system.

### DETAILED DESCRIPTION OF THE INVENTION

In the following description, certain specific details are set forth in order to provide a thorough understanding of various embodiments of the invention. However, one skilled in the art will understand that the invention may be practiced without these details. In other instances, well known structures associated with fuel cells, microcontrollers, sensors, and actuators have not been described in detail to avoid unnecessarily obscuring the descriptions of the embodiments of the invention.

Unless the context requires otherwise, throughout the specification and claims which follow, the word “comprise” and variations thereof, such as “comprises” and “comprising” are to be construed in an open, inclusive sense, that is as “including but not limited to.”

Fuel Cell System Overview

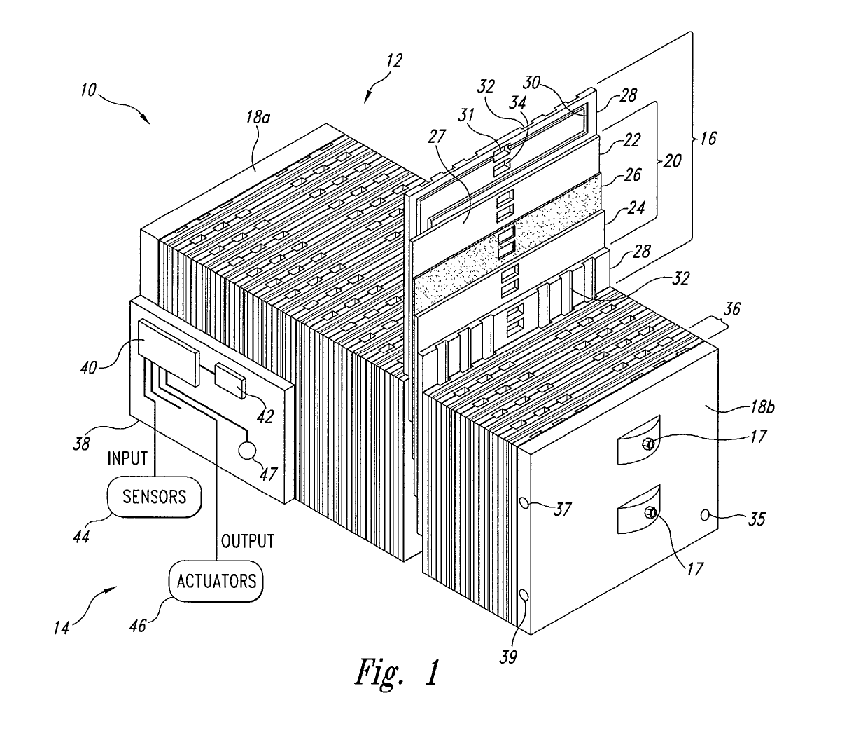

FIG. 1 shows a portion of a fuel cell system 10, namely, a fuel cell stack 12 and an electronic fuel cell control system 14. Fuel cell stack 12 includes a number of fuel cell assemblies 16 arranged between a pair of end plates 18a, 18b, one of the fuel cell assemblies 16 being partially removed from fuel cell stack 12 to better illustrate the structure of fuel cell assembly 16. Tie rods (not shown) extend between end plates 18a, 18b and cooperate with fastening nuts 17 to bias end plates 18a, 18b together by applying pressure to the various components to ensure good contact therebetween.

Each fuel cell assembly 16 includes a membrane electrode assembly 20 including two electrodes, the anode 22 and the cathode 24, separated by an ion exchange membrane 26. Electrodes 22, 24 can be formed from a porous, electrically conductive sheet material, such as carbon fiber paper or cloth, that is permeable to the reactants. Each of electrodes 22, 24 is coated on a surface adjacent the ion exchange membrane 26 with a catalyst 27, such as a thin layer of platinum, to render each electrode electrochemically active.

Fuel cell assembly 16 also includes a pair of separators or flow field plates 28 sandwiching membrane electrode assembly 20. In the illustrated embodiment, each of flow field plates 28 includes one or more reactant channels 30 formed on a planar surface of flow field plate 28 adjacent an associated one of electrodes 22, 24 for carrying fuel to anode 22 and oxidant to cathode 24, respectively. (Reactant channel 30 on only one of flow field plates 28 is visible in FIG. 1.) Reactant channels 30 that carry the oxidant also carry exhaust air and product water away from cathode 24. As will be described in more detail below, fuel stack 12 is designed to operate in a dead-ended fuel mode, thus substantially all of the hydrogen fuel supplied to it during operation is consumed, and little if any hydrogen is carried away from stack 12 in normal operation of system 10. However, embodiments of the present invention can also be applicable to fuel cell systems operating on dilute fuels which are not dead-ended.

In the illustrated embodiment, each flow field plate 28 preferably includes a plurality of cooling channels 32 formed on the planar surface of flow field plate 28 opposite the planar surface having reactant channel 30. When the stack 12 is assembled, cooling channels 32 of each adjacent fuel cell assembly 16 cooperate so that closed cooling channels 32 are formed between each membrane electrode assembly 20. Cooling channels 32 transmit cooling air through fuel stack 12. Cooling channels 32 are preferably straight and parallel to each other, and traverse each plate 28 so that cooling channel inlets and outlets are located at respective edges of plate 28.

While the illustrated embodiment includes two flow field plates 28 in each fuel cell assembly 16, other embodiments can include a single bipolar flow field plate (not shown) between adjacent membrane electrode assemblies 20. In such embodiments, a channel on one side of the bipolar plate carries fuel to the anode of one adjacent membrane electrode assembly 20, while a channel on the other side of the plate carries oxidant to the cathode of another adjacent membrane electrode assembly 20. In such embodiments, additional flow field plates 28 having channels for carrying coolant (e.g., liquid or gas, such as cooling air) can be spaced throughout fuel cell stack 12, as needed to provide sufficient cooling of stack 12.

End plate 18a includes a fuel stream inlet port (not shown) for introducing a supply fuel stream into fuel cell stack 12. End plate 18b includes a fuel stream outlet port 35 for discharging an exhaust fuel stream from fuel cell stack 12 that comprises primarily water and non-reactive components and impurities, such as any introduced in the supply fuel stream or entering the fuel stream in stack 12. Fuel stream outlet port 35 is normally closed with a valve in dead-ended operation. Although fuel cell stack 12 is designed to consume substantially all of the hydrogen fuel supplied to it during operation, traces of unreacted hydrogen may also be discharged through the fuel stream outlet port 35 during a purge of fuel cell stack 12, effected by temporarily opening a valve at fuel stream outlet port 35. Each fuel cell assembly 16 has openings formed therein to cooperate with corresponding openings in adjacent assemblies 16 to form internal fuel supply and exhaust manifolds (not shown) that extend the length of stack 12. The fuel stream inlet port is fluidly connected to fluid outlet port 35 via respective reactant channels 30 that are in fluid communication with the fuel supply and exhaust manifolds, respectively.

End plate 18b includes an oxidant stream inlet port 37 for introducing supply air (oxidant stream) into fuel cell stack 12, and an oxidant stream outlet port 39 for discharging exhaust air from fuel cell stack 12. Each fuel cell assembly 16 has openings 31, 34, formed therein to cooperate with corresponding openings in adjacent fuel cell assemblies 16 to form oxidant supply and exhaust manifolds that extend the length of stack 12. Oxidant inlet port 37 is fluidly connected to the oxidant outlet port 39 via respective reactant channels 30 that are in fluid communication with oxidant supply and exhaust manifolds, respectively.

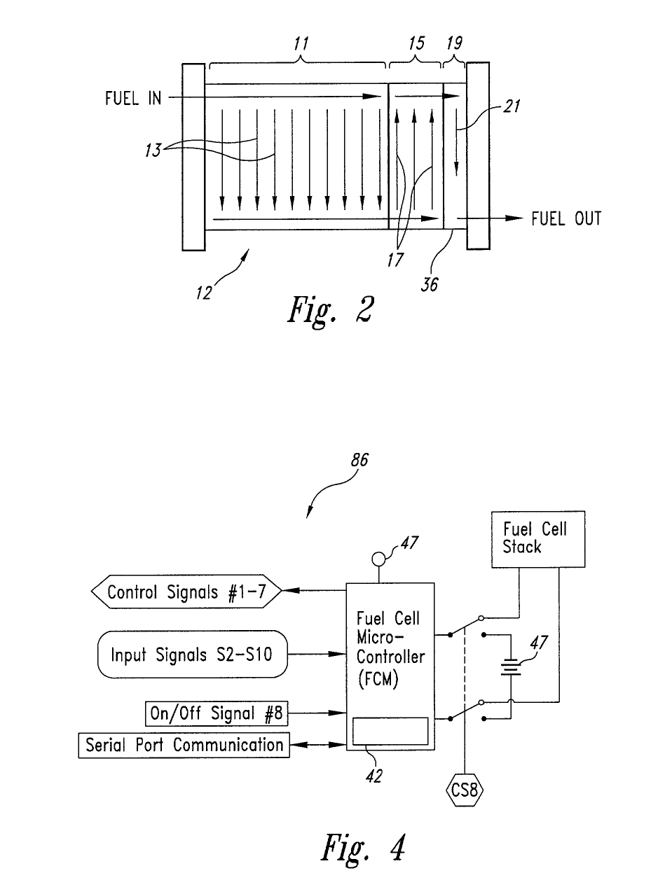

In one embodiment, fuel cell stack 12 includes forty-seven fuel cell assemblies 16. (FIGS. 1 and 2 omit a number of the fuel cell assemblies 16 to enhance drawing clarity). Fuel cell stack 12 can include a greater or lesser number of fuel cell assemblies to provide more or less power, respectively.

As shown in FIG. 2, fuel is directed through fuel cell stack 12 in a cascaded flow pattern. A first set 11 composed of the first forty-three fuel cell assemblies 16 are arranged so that fuel flows within the set in a concurrent parallel direction (represented by arrows 13) that is generally opposite the direction of the flow of coolant through fuel cell stack 12. Fuel flow through a next set 15 of two fuel cell assemblies 16 is in series with respect to the flow of fuel in the first set 11, and in a concurrent parallel direction within the set 15 (in a direction represented by arrows 17) that is generally concurrent with the direction of the flow of coolant through fuel cell stack 12. Fuel flow through a final set 19 of two fuel cells assemblies 16 is in series with respect to the first and second sets 11, 15, and in a concurrent parallel direction within the set 19 (in a direction represented by arrow 21) generally opposite the flow of coolant through the fuel cell stack 12. The oxidant is supplied to each of the forty-seven fuel cells in parallel, in the same general direction as the flow of coolant through fuel cell stack 12.

The final set 19 of fuel cell assemblies 16 comprises the purge cell portion 36 of the fuel cell stack. The purge cell portion 36 accumulates non-reactive components which are periodically vented by opening a purge valve.

Each membrane electrode assembly 20 is designed to produce a nominal potential difference of about 0.6 V between anode 22 and cathode 24. Reactants (hydrogen and air) are supplied to electrodes 22, 24 on either side of ion exchange membrane 26 through reactant channels 30. Hydrogen is supplied to anode 22, where platinum catalyst 27 promotes its separation into protons and electrons, which pass as useful electricity through an external circuit (not shown). On the opposite side of membrane electrode assembly 20, air flows through reactant channels 30 to cathode 24 where oxygen in the air reacts with protons passing through the ion exchange membrane 26 to produce product water.

Fuel Cell System Sensors and Actuators

With continuing reference to FIG. 1, the electronic control system 14 comprises various electrical and electronic components on a circuit board 38 and various sensors 44 and actuators 46 distributed throughout fuel cell system 10. Circuit board 38 carries a microprocessor or microcontroller 40 that is appropriately programmed or configured to carry out fuel cell system operation. Microcontroller 40 can take the form of an Atmel AVR RISC microcontroller available from Atmel Corporation of San Jose, Calif. The electronic control system 14 also includes a persistent memory 42, such as an EEPROM portion of microcontroller 40 or discrete nonvolatile controller-readable media.

Microcontroller 40 is coupled to receive input from sensors 44 and to provide output to actuators 46. The input and/or output can take the form of either digital and/or analog signals. A rechargeable battery 47 powers electronic control system 14 until fuel cell stack 12 can provide sufficient power to the electronic control system 14. Microcontroller 40 is selectively couplable between fuel cell stack 12 and battery 47 for switching power during fuel cell system operation and/or to recharge battery 47 during fuel cell operation.

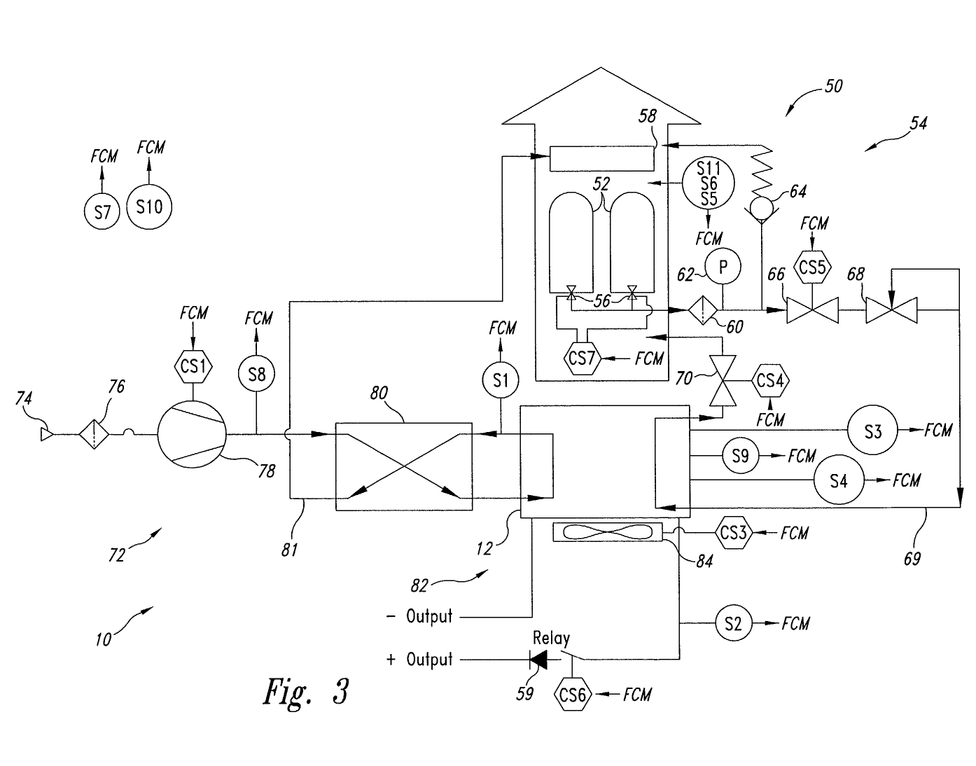

FIG. 3 show various elements of fuel cell system 10 in further detail, and shows various other elements that were omitted from FIG. 1 for clarity of illustration.

With particular reference to FIG. 3, fuel cell system 10 provides fuel (e.g., hydrogen) to anode 22 by way of a fuel system 50. Fuel system 50 includes a source of fuel such as one or more fuel tanks 52, and a fuel regulating system 54 for controlling delivery of the fuel. Fuel tanks 52 can contain hydrogen, or some other fuel such as methanol. Alternatively, fuel tanks 52 can represent a process stream from which hydrogen can be derived by reforming, such as methane or natural gas (in which case a reformer is provided in fuel cell system 10).

Fuel tanks 52 each include a fuel tank valve 56 for controlling the flow of fuel from the respective fuel tank 52. Fuel tank valves 56 may be automatically controlled by microcontroller 40, and/or manually controlled by a human operator. Fuel tanks 52 may be refillable, or may be disposable. Fuel tanks 52 may be integral to the fuel system 50 and/or fuel cell system 10, or can take the form of discrete units. In this embodiment, fuel tanks 52 are hydride storage tanks. Fuel tanks 52 are positioned within fuel cell system 10 such that they are heatable by exhaust cooling air warmed by heat generated by fuel cell stack 12. Such heating facilitates the release of hydrogen from the hydride storage media.

Fuel cell control system 14 includes a hydrogen concentration sensor S5, hydrogen heater current sensor S6 and a hydrogen sensor check sensor S11. Hydrogen heater current sensor S6 can take the form of a current sensor that is coupled to monitor a hydrogen heater element that is an integral component of hydrogen concentration sensor S5. Hydrogen sensor check sensor S11 monitors voltage across a positive leg of a Wheatstone bridge in a hydrogen concentration sensor S5, discussed below, to determine whether hydrogen concentration sensor S5 is functioning.

The fuel tanks 52 are coupled to fuel regulating system 54 through a filter 60 that ensures that particulate impurities do not enter fuel regulating system 54. Fuel regulating system 54 includes a pressure sensor 62 to monitor the pressure of fuel in fuel tanks 52, which indicates how much fuel remains in fuel tanks 52. A pressure relief valve 64 automatically operates to relieve excess pressure in fuel system 50. Pressure relief valve 64 can take the form of a spring and ball relief valve. A main gas valve solenoid CS5 opens and closes a main gas valve 66 in response to signals from microcontroller 40 to provide fluid communication between fuel tanks 52 and fuel regulating system 54. Additional fuel tank controllers CS7 such as solenoids control flow through the fuel tank valves 56. A hydrogen regulator 68 regulates the flow of hydrogen from fuel tanks 52. Fuel is delivered to the anodes 22 of the fuel cell assemblies 16 through a hydrogen inlet conduit 69 that is connected to fuel stream inlet port of stack 12.

Sensors 44 of fuel regulating system 54 monitor a number of fuel cell system operating parameters to maintain fuel cell system operation within acceptable limits. For example, a stack voltage sensor S3 measures the gross voltage across fuel cell stack 12. A purge cell voltage sensor S4 monitors the voltage across purge cell portion 36 (the final set 19 of fuel cell assemblies 16 in cascaded design of FIG. 2). A cell voltage checker S9 ensures that a voltage across each of the fuel cell assemblies 16 is within an acceptable limit. Each of the sensors S3, S4, S9 provide inputs to microcontroller 40, identified in FIG. 3 by arrows pointing toward the blocks labeled “FCM” (i.e., fuel cell microcontroller 40).

A fuel purge valve 70 is provided at fuel stream outlet port 35 of fuel cell stack 12 and is typically in a closed position when stack 12 is operating. Fuel is thus supplied to fuel cell stack 12 only as needed to sustain the desired rate of electrochemical reaction. Because of the cascaded flow design, any impurities (e.g., nitrogen) in the supply fuel stream tend to accumulate in purge cell portion 36 during operation. A build-up of impurities in purge cell portion 36 tends to reduce the performance of purge cell portion 36; should the purge cell voltage sensor S4 detect a performance drop below a threshold voltage level, microcontroller 40 may send a signal to a purge valve controller CS4 to open the purge valve 36 and discharge the impurities and other non-reactive components that may have accumulated in purge cell portion 36 (collectively referred to as “purge discharge”). The venting of hydrogen by the purge valve 70 during a purge is limited (on a continuous basis) to prevent the ambient environment monitoring and control systems, discussed below, from triggering a failure or fault.

Fuel cell system 10 provides oxygen in an air stream to the cathode side of membrane electrode assemblies 20 by way of an oxygen delivery system 72. A source of oxygen or air 74 can take the form of an air tank or the ambient atmosphere. A filter 76 ensures that particulate impurities do not enter oxygen delivery system 72. An air compressor controller CS1 controls an air compressor 78 to provide the air to fuel cell stack 12 at a desired flow rate. A mass air flow sensor S8 measures the air flow rate into fuel cell stack 12, providing the value as an input to microcontroller 40. A humidity exchanger 80 adds water vapor to the air to keep the ion exchange membrane 26 moist. Humidity exchanger 80 also removes water vapor which is a byproduct of the electrochemical reaction. Excess liquid water is provided to an evaporator 58.

Fuel cell system 10 removes excess heat from fuel cell stack 12 and may use the excess heat to warm the fuel in fuel tanks 52 by way of a cooling system 82. The cooling system 82 includes a fuel cell temperature sensor S1, for example a thermister that monitors the core temperature of fuel cell stack 12. The temperature is provided as input to microcontroller 40. A stack current sensor S2, for example a Hall effect sensor, measures the gross current through fuel cell stack 12, and provides the value of the current as an input to microcontroller 40. A cooling fan controller CS3 controls the operation of one or more cooling fans 84 for cooling fuel cell stack 12. After passing through fuel cell stack 12, the warmed cooling air circulates around fuel tanks 52 to warm the fuel. The warmed cooling air then passes by the evaporator 58. A power circuit relay controller CS6 connects, and disconnects, the fuel cell to, and from, an external circuit in response to microcontroller 40. A power diode 59 provides one-way isolation of fuel cell system 10 from the external load to provide protection to fuel cell system 10 from the external load. A battery relay controller CS8 connects, and disconnects, fuel cell control system 14 between fuel cell stack 12 and the battery 47.

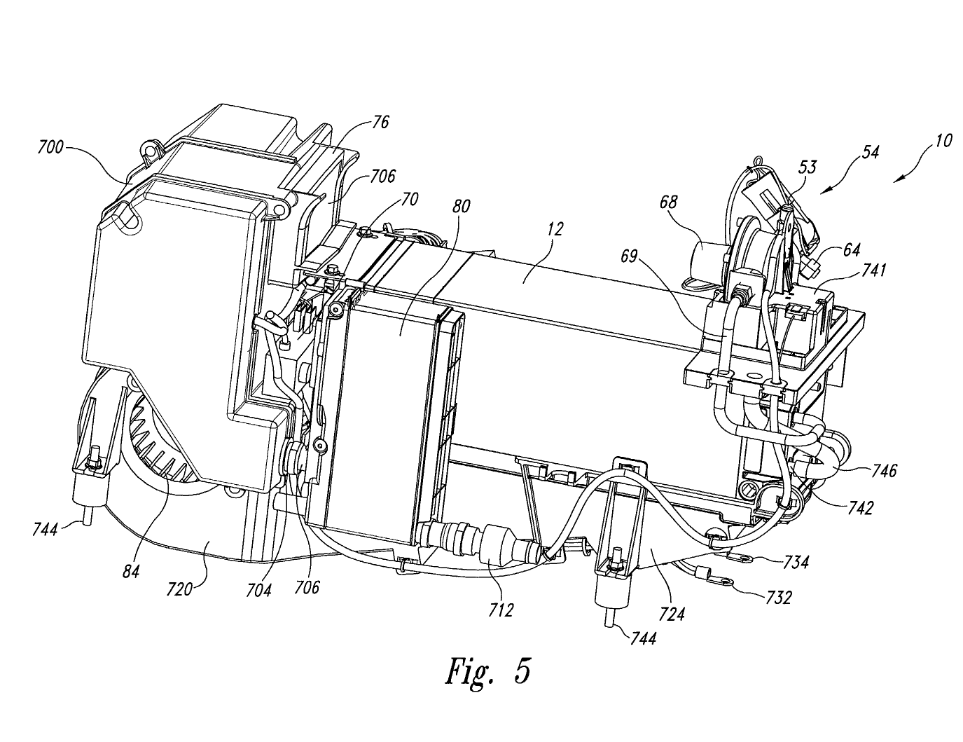

The fuel cell monitoring and control system 14 (illustrated in FIG. 4) includes sensors for monitoring fuel cell system 10 surroundings and actuators for controlling fuel cell system 10 accordingly. For example, a hydrogen concentration sensor S5 (shown in FIG. 3) for monitoring the hydrogen concentration level in the ambient atmosphere surrounding fuel cell stack 12. The hydrogen concentration sensor S5 can take the form of a heater element with a hydrogen sensitive thermister that may be temperature compensated. An oxygen concentration sensor S7 (illustrated in FIG. 4) to monitor the oxygen concentration level in the ambient atmosphere surrounding fuel cell system 10. An ambient temperature sensor S10 (shown in FIG. 3), for example a digital sensor, to monitor the ambient air temperature surrounding fuel cell system 10.

With reference to FIG. 4, microcontroller 40 receives the various sensor measurements such as ambient air temperature, fuel pressure, hydrogen concentration, oxygen concentration, fuel cell stack current, air mass flow, cell voltage check status, voltage across the fuel cell stack, and voltage across the purge cell portion of the fuel cell stack from various sensors described below. Microcontroller 40 provides the control signals to the various actuators, such as air compressor controller CS1, cooling fan controller CS3, purge valve controller CS4, main gas valve solenoid CS5, power circuit relay controller CS6, hydride tank valve solenoid CS7, and battery relay controller CS8.

Fuel Cell System Structural Arrangement

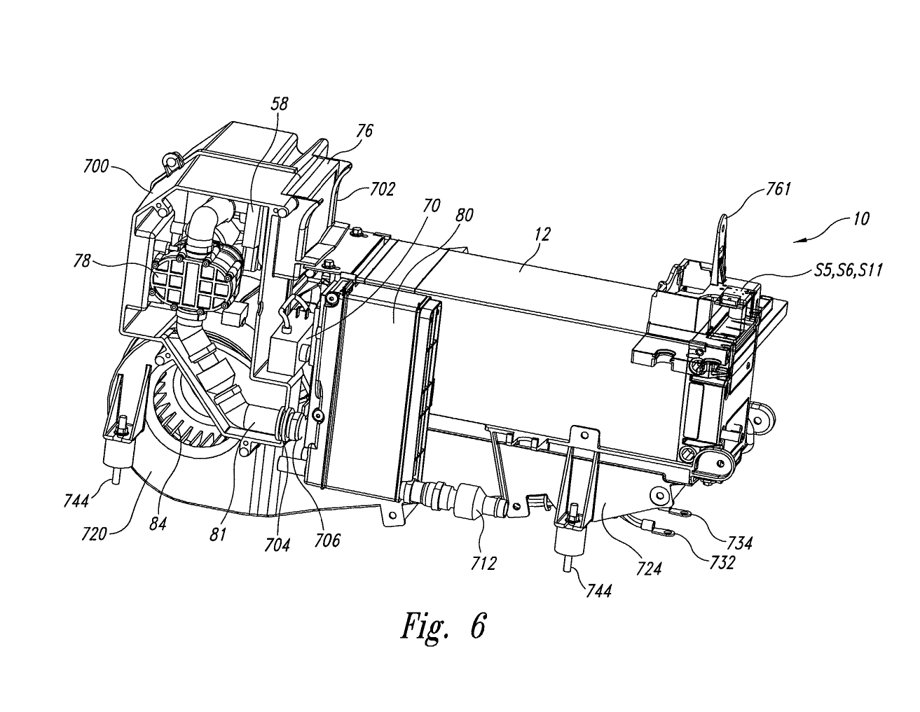

FIGS. 5-8 illustrate the structural arrangement of the components in fuel cell system 10. For convenience, “top”, “bottom”, “above”, “below” and similar descriptors are used merely as points of reference in the description, and while corresponding to the general orientation of the illustrated fuel cell system 10 during operation, are not to be construed to limit the orientation of fuel cell system 10 during operation or otherwise.

Referring to FIGS. 5-7, the air compressor 78 and cooling fan 84 are grouped together at one end (“air supply end”) of fuel cell stack 12. Fuel tanks 52 (not shown in FIGS. 5-7) are mountable to fuel cell system 10 on top of, and along the length of, fuel cell stack 12. The components of fuel regulating system 54 upstream of fuel cell stack 12 are located generally at the end of stack 12 (“hydrogen supply end”) opposite the air supply end.

The air compressor 78 is housed within an insulated housing 700 that is removably attached to fuel cell stack 12 at the air supply end. The housing 700 has an air supply aperture 702 covered by the filter 76 that allows supply air into housing 700. The air compressor 78 is a positive displacement low pressure type compressor and is operable to transmit supply air to air supply conduit 81 at a flow rate controllable by the operator. An air supply conduit 81 passes through a conduit aperture 704 in compressor housing 700 and connects with an air supply inlet 706 of humidity exchanger 80. Mass flow sensor S8 is located on an inlet of air compressor 78 and preferably within the compressor housing 700.

The humidity exchanger 80 may be of the type disclosed in U.S. Pat. No. 6,106,964, and is mounted to one side of fuel cell stack 12 near the air supply end. Air entering into the humidity exchanger 80 via air supply conduit 81 is humidified and then exhausted from the humidity exchanger 80 and into fuel cell stack 12 (via the supply air inlet port of the end plate 18b). Exhaust air from fuel cell stack 12 exits via the exhaust air outlet port in end plate 18b and into the humidity exchanger 80, where water in the air exhaust stream is transferred to the air supply stream. The air exhaust stream then leaves the humidity exchanger 80 via the air exhaust outlet 712 and is transmitted via an air exhaust conduit (not shown) to the evaporator 58 (not shown in FIGS. 5-7) mountable to a cover (not shown) above fuel cell stack 12.

Cooling fan 84 is housed within a fan housing 720 that is removably mounted to the air supply end of fuel cell stack 12 and below the compressor housing 700. Fan housing 720 includes a duct 724 that directs cooling air from the cooling fan 84 to the cooling channel openings at the bottom of fuel cell stack 12. Cooling air is directed upwards and through fuel cell stack 12 (via cooling channels 32) and is discharged from the cooling channel openings at the top of fuel cell stack 12. During operation, heat extracted from fuel cell stack 12 by the cooling air is used to warm fuel tanks 52 that are mountable directly above and along the length of stack 12. Some of the warmed cooling air can be redirected into the air supply aperture 702 of the compressor housing 700 for use as oxidant supply air.

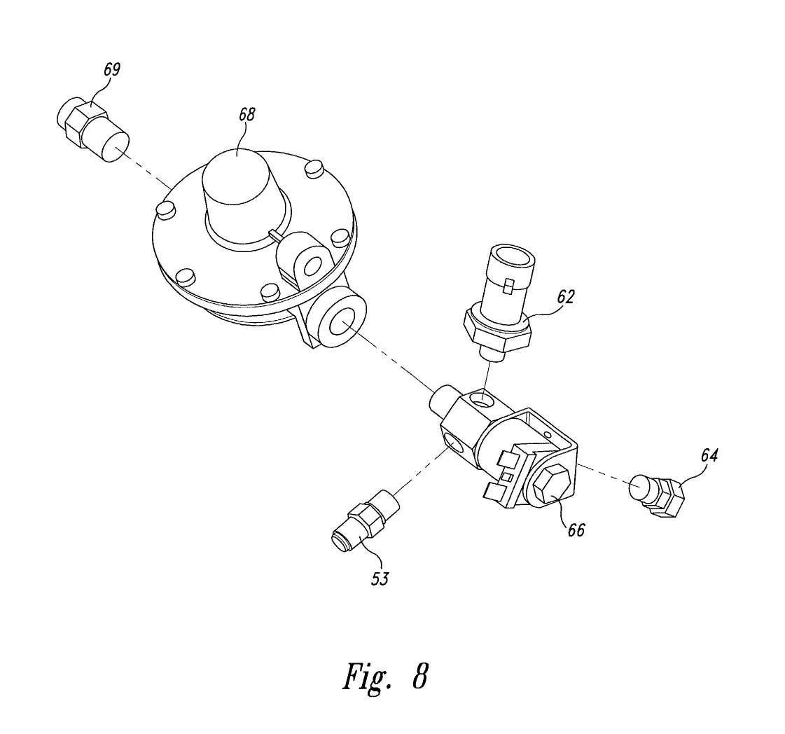

Referring particularly to FIG. 7, circuit board 38 carrying microcontroller 40, oxygen sensor S7 and ambient temperature sensor S10 is mounted on the side of fuel cell stack 12 opposite humidity exchanger 80 by way of a mounting bracket 730. Positive and negative electrical power supply lines 732, 734 extend from each end of fuel cell stack 12 and are connectable to an external load. An electrically conductive bleed wire 736 from each of the power supply lines 732, 734 connects to the circuit board 38 at a stack power in terminal 738 and transmits some of the electricity generated by fuel cell stack 12 to power the components on the circuit board 38, as well as sensors 44 and actuators 46 which are electrically connected to circuit board 38 at terminal 739. Similarly, battery 47 (not shown in FIGS. 5-7) is electrically connected to circuit board 38 at battery power in terminal 740. Battery 47 supplies power to the circuit board components, sensors 44 and actuators 46 when fuel cell stack output has not yet reached nominal levels (e.g., at start-up); once fuel cell stack 12 has reached nominal operating conditions, fuel cell stack 12 can also supply power to recharge battery 47.

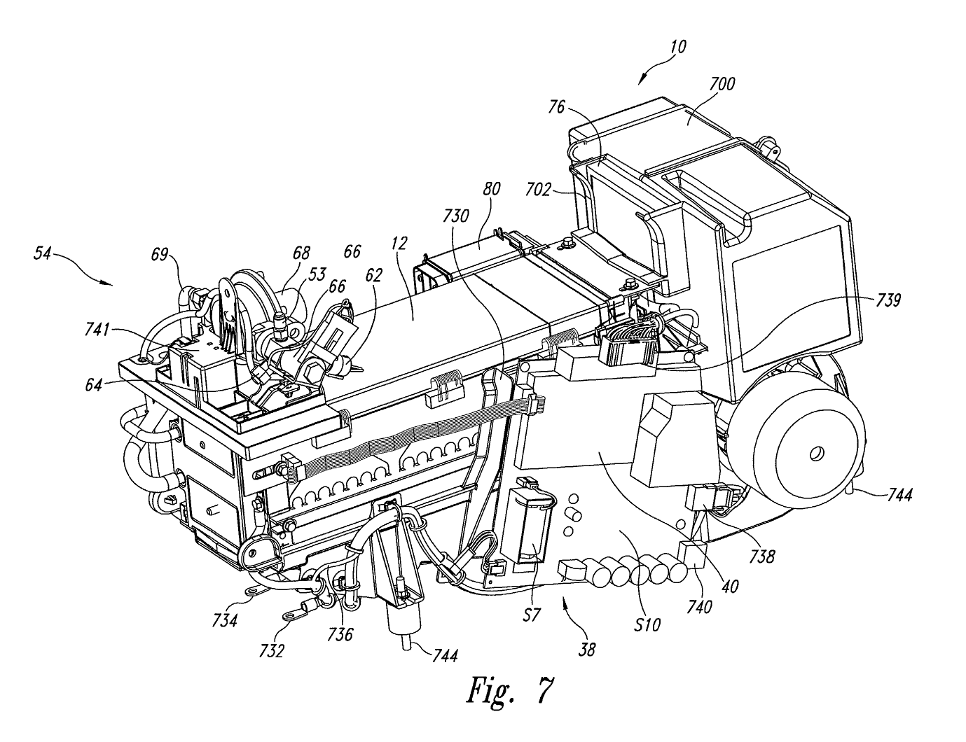

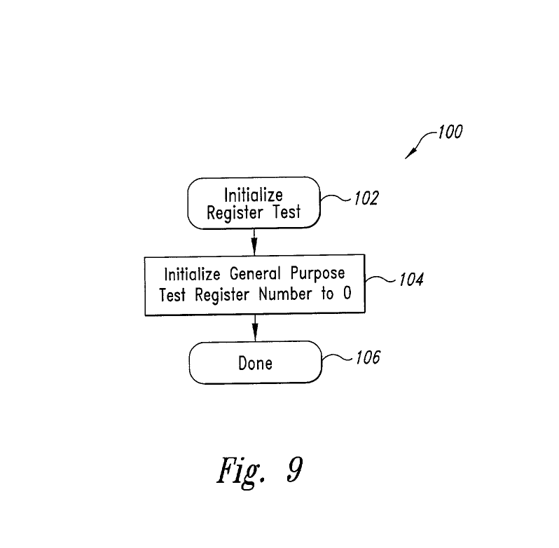

Referring generally to FIGS. 5-7 and particularly to FIG. 8, a bracket 741 is provided at the hydrogen supply end for the mounting of fuel tank valve connector 53, hydrogen pressure sensor 62, pressure relief valve 64, main gas valve 66, and hydrogen pressure regulator 68 above fuel cell stack 12 at the hydrogen supply end. A suitable pressure regulator may be a Type 912 pressure regulator available from Fisher Controls of Marshalltown, Iowa. A suitable pressure sensor may be a transducer supplied Texas Instruments of Dallas, Tex. A suitable pressure relief valve may be supplied by Schraeder-Bridgeport of Buffalo Grove, Ill. The pressure relief valve 64 is provided for fuel tanks 52 and may be set to open at about 350 psi. A low pressure relief valve 742 is provided for fuel cell stack 12. Bracket 741 also provides a mount for hydrogen concentration sensor S5, hydrogen heater current sensor S6 and hydrogen sensor check sensor S11, which are visible in FIG. 6 in which the bracket 741 is transparently illustrated in hidden line. Fuel tanks 52 are connectable to the fuel tank connector 53. When valves 56, 66 are opened, hydrogen is supplied under a controlled pressure (monitored by pressure sensor 62 and adjustable by hydrogen pressure regulator 68) through the fuel supply conduit 69 to the fuel inlet port of end plate 18a. Purge valve 70 is located at the fuel outlet port at end plate 18b.

Fuel cell system 10 and fuel tanks 52 are coupled to a base (not shown) at mounting points 744 and housed within a fuel cell system cover (not shown). Cooling air exhausted from the top of fuel cell stack 12 is thus directed by the cover either to the supply air inlet 702 or over fuel regulating system 54 to a cooling air discharge opening in the housing.

Fuel cell system 10 is designed so that components that are designed to discharge hydrogen or that present a risk of leaking hydrogen, are as much as practical, located in the cooling air path or have their discharge/leakage directed to the cooling air path. The cooling air path is defined by duct 724, cooling air channels of stack 12, and the portion of the system cover above stack 12; a cooling air stream passing through the cooling air path is shown by the arrows in FIGS. 5, 6 and 7. The components directly in the cooling air path include fuel tanks 52, and components of fuel regulating system 54 such as pressure relief valve 64, main gas valve 66, and hydrogen regulator 68. Components not directly in the cooling air path are fluidly connected to the cooling air path, and include purge valve 70 connected to duct 724 via purge conduit (not shown) and low pressure relief valve 742 connected to an outlet near fuel regulating system 54 via conduit 746. When cooling air fan 84 is operational, the cooling air stream carries leaked/discharged hydrogen through duct 724, past stack 12, and out of system 10 in the direction of the arrows shown in FIGS. 5, 6, and 7. Hydrogen concentration sensor S5 is strategically placed as far downstream as possible in the cooling air stream to detect hydrogen carried in the cooling airstream.

Hydrogen concentration sensor S5 is also placed in the vicinity of the components of fuel regulating system 54 to improve detection of hydrogen leaks/discharges from fuel regulating system 54.

Exemplary Method of Operation

Fuel cell system 10 can employ a number of operating states that may determine which operations or tasks microcontroller 40 executes, and may determine the response of microcontroller 40 to various readings or measurements of the fuel cell system operating parameters. Microcontroller 40 executes software that can be programmed into and executed from an on-chip flash memory of microcontroller 40 or in other controller-readable memory. In particular, fuel cell system 10 can employ a standby state, starting state, running state, warning state, failure state, and stopping state.

In a standby state fuel cell stack 12 is not operating and microcontroller 40 monitors a startline for a startup signal. For example, operator activation of a start button or switch (not shown) can generate the startup signal on the startup line.

In a starting state, microcontroller 40 initializes itself, places all actuators and control devices in their proper initial states, enables a serial interface, starts a watchdog timer, and performs a series of checks to ensure that all systems and components are operational. If the outcomes of the checks are satisfactory, microcontroller 40 causes the external load to be connected and enters a running state, otherwise fuel cell system 10 enters a failure state without becoming operational.

In a running state, fuel and oxidant are supplied to the fully operational fuel cell stack 12. Microcontroller 40 monitors the performance of fuel cell system 10 based on the measured operating parameters, and controls the various systems via the various actuators discussed above. If microcontroller 40 determines that one or more operating parameters are outside of a warning range, microcontroller 40 places fuel cell system 10 into a warning state. If microcontroller 40 determines that one or more operating parameters are outside of a failure range, microcontroller 40 places the fuel cell system into a failure state. Otherwise, fuel cell system 10 continues in a running state until a stop signal is received on the startup line. In response to the stop signal, microcontroller 40 advances fuel cell system 10 from a running state to a stopping state if fuel cell system 10 has been in a running state for at least one minute. If so, the microcontroller 40 begins an extended shutdown procedure lasting approximately 45 seconds, during which time the fuel cell system 12 is in a stopping state. If not, microcontroller 40 engages the normal shutdown procedure and fuel cell system 10 proceeds directly from a running state to a standby state.

In a warning state, microcontroller 40 can provide a warning notification of the out-of-warning-range condition to the operator, but otherwise fuel cell system 10 continues to operate. Additionally, microcontroller 40 can write a warning condition code corresponding to the out-of-warning-range condition to the persistent memory 42.

In a failure state, microcontroller 40 immediately stops operation of fuel cell system 10 and writes a fault condition code to the persistent memory 42. Fuel cell system 10 remains in a failure state until a stop signal is received on the startline. In response to the stop signal, microcontroller 40 completes the shut down of fuel cell system 10 and places fuel cell system 10 into a standby state.

In a stopping state, microcontroller 40 shuts down the various components of fuel cell system 10, stopping operation of fuel cell system 10. Once the various components have been shut down, microcontroller 40 places fuel cell system 10 into a standby state.

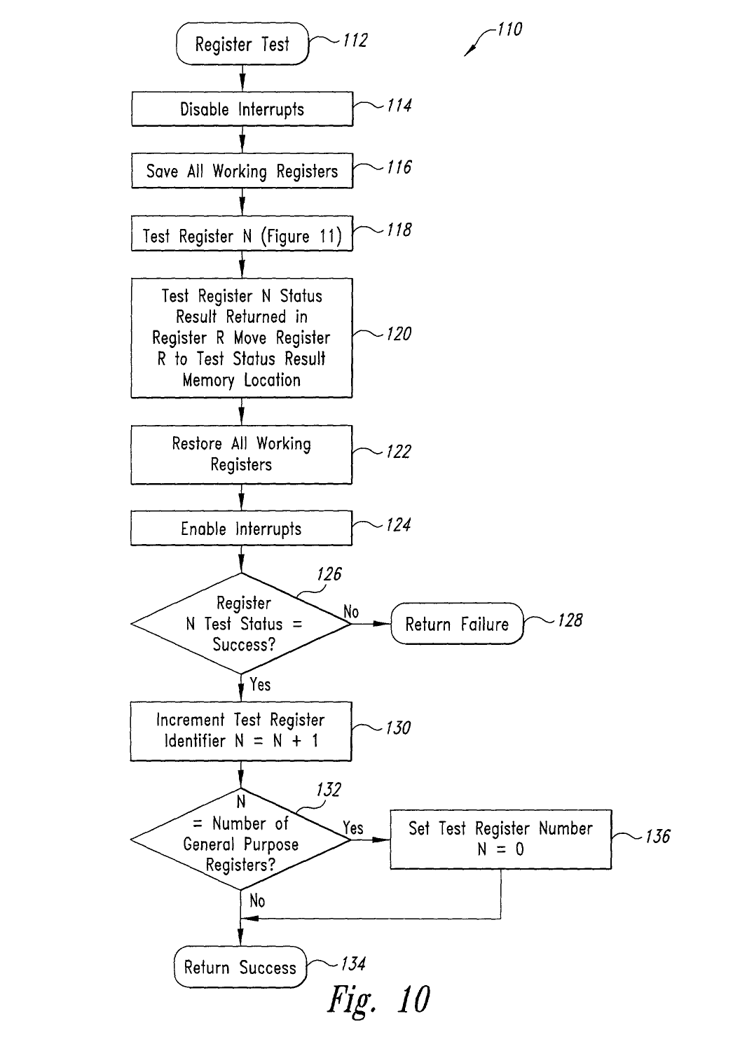

FIG. 9 shows a method 100 of initializing a test for the general purpose registers of microcontroller 40, starting in step 102. In step 104, microcontroller 40 sets the general purpose test register number to 0. Microcontroller 40 stores the general purpose test register number in a memory location that is not overwritten by the testing process, such as a random access memory (“RAM”) (not shown) or in the persistent memory 42. Microcontroller 40 terminates the initialize register test method 100 in step 106. The initialize register test method 100 sets the general purpose register test number such that the register test method 110, described below, begins with a first one of the general purpose registers of microcontroller 40.

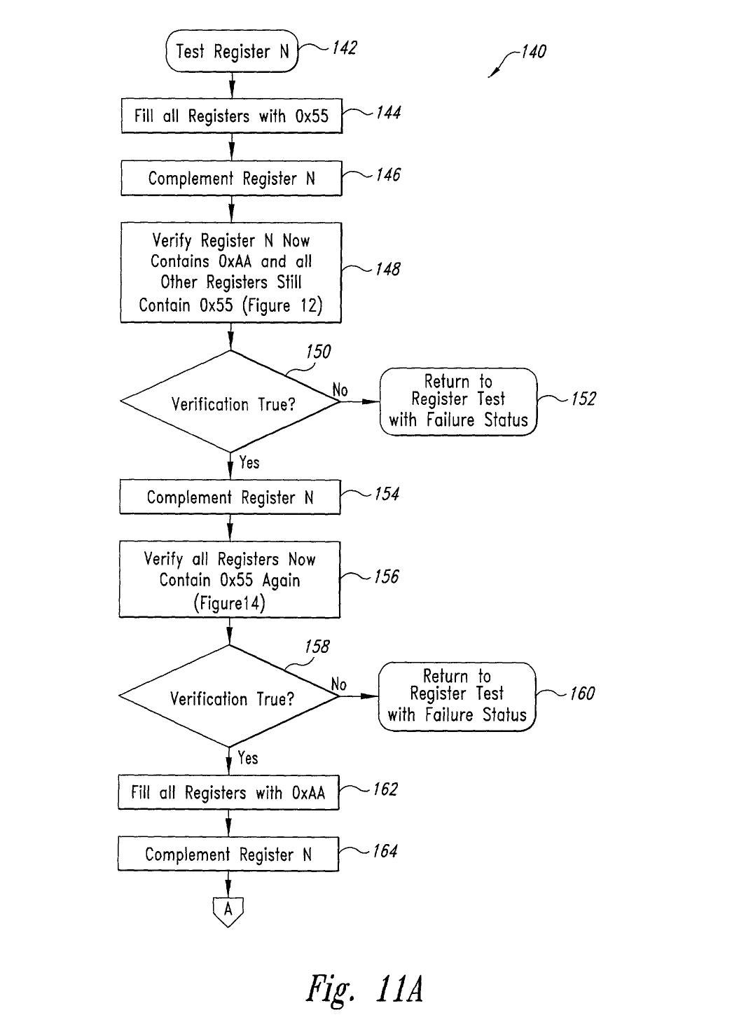

FIG. 10 shows the register test method 110, starting in step 112. The register test method 110 may be the main routine from which other functions, described below, are called. In step 114, microcontroller 40 disables interrupts, temporarily preventing interrupt requests to microcontroller 40 from being serviced. In step 116, microcontroller 40 saves the content of all general purpose registers to a memory location that is not overwritten by the testing process, such as RAM or persistent memory 42, for example, by saving the contents of the general purpose registers as global values.

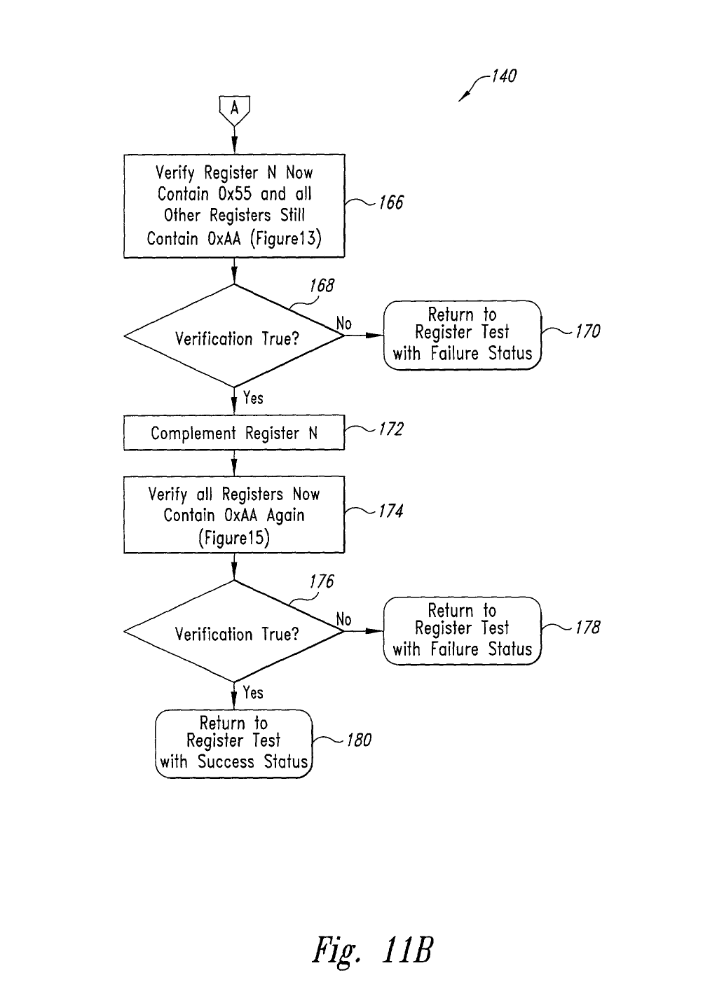

In step 118, microcontroller 40 performs a test of the Nth general purpose register, which is described in detail below with reference to FIG. 11. The initialize register test method 100 initializes the general purpose test register number to 0, such that the value N begins with 0, and is incremented to test each of the general purpose registers of microcontroller 40. This incremental approach allows the testing of the general purpose registers to be spread across a number of passes through the scheduling of operations discussed in detail in commonly assigned U.S. patent application Ser. No. ______, entitled FUEL CELL SYSTEM METHOD, APPARATUS AND SCHEDULING (Atty. Docket No. 130109.409). Thus, microcontroller 40 may test a number of general purpose registers less than the total number of general purpose registers, and may even test only a portion of one general purpose register during each pass through the schedule of operations. Additionally, or alternatively, microcontroller 40 may only perform a partial test for a general purpose register during a single pass through the schedule of operations, for example, testing one pattern of bits in each pass. This approach facilitates load distributing for microcontroller 40.

In step 120, microcontroller 40 tests the register and status result which is returned in a special purpose register such as a status register R of microcontroller 40. Microcontroller 40 then moves the contents of the status register R to a memory location that will not be overwritten, in preparing to complete the portion of register testing in anticipation of the next scheduled task (e.g., monitoring stack voltage). In step 122, microcontroller 40 restores the contents of all of the general purpose registers from the memory location. In step 124, microcontroller 40 enables the interrupts.

In step 126, microcontroller 40 determines whether the test of the Nth general purpose register was successful. Microcontroller 40 returns a failure condition in step 128 if the test of the Nth general purpose register is not successful. If the test of the Nth general purpose register is successful, microcontroller 40 increments the test register identifier (i.e., N=N+1) in step 130. In step 132, microcontroller 40 determines if N is equal to the total number of general purpose registers. If microcontroller 40 determines in step 132 that all registers have not been tested (i.e., N<Total number of General Purpose Registers), microcontroller 40 returns a successful condition in step 134. If microcontroller 40 determines in step 132 that all general purpose registers have been tested (i.e., N=Total number of General Purpose Registers), microcontroller 40 resets test register number to N equal 0 in step 136, and returns a successful condition.

Thus, microcontroller 40 is able to perform a portion of the self test in increments small enough to be executed in the time allotted for each slot in the schedule of operations or tasks. Each time microcontroller 40 performs a register test, it disables the interrupts and saves the general purpose registers, restoring the general purpose registers and enabling the interrupts after completing the particular portion of the register testing before executing the next operation or task in the schedule.

FIGS. 11A and 11B combined show a method 140 of testing the Nth register, that microcontroller 40 can perform as step 118 of the register test method 110 (FIG. 10). The method 140 for testing register N starts in step 142.

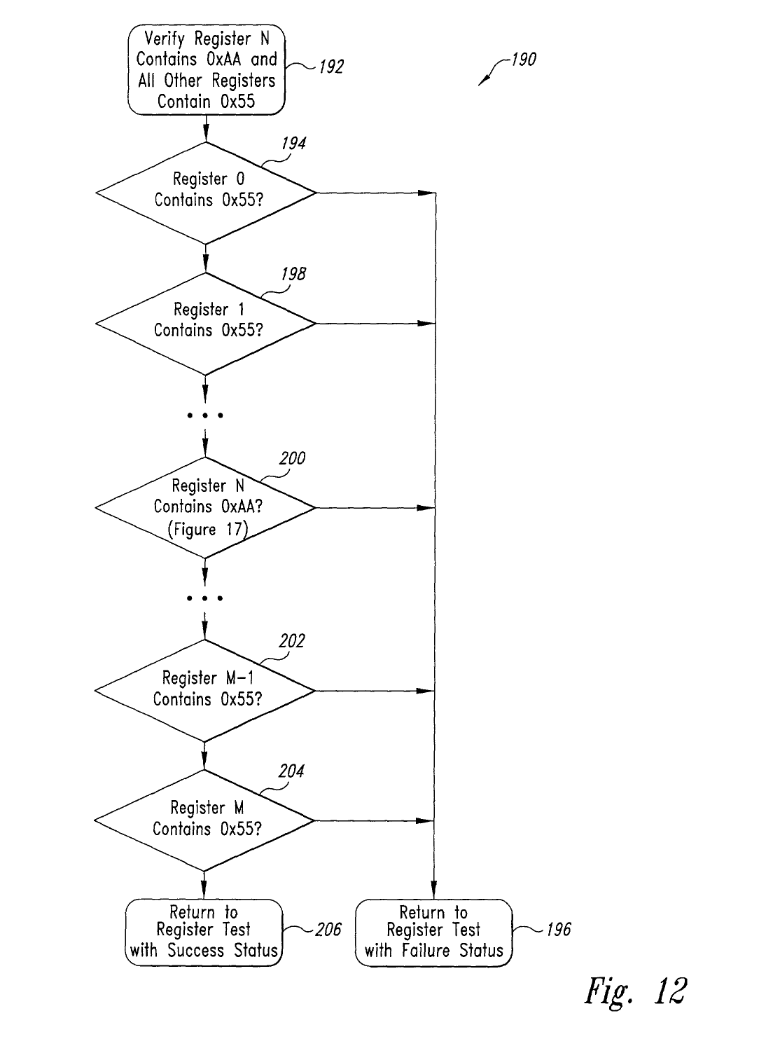

In step 144, microcontroller 40 fills all general purpose registers with the hexadecimal value 0x55. The hexadecimal value 0x55 corresponds to the bit pattern 01010101. In step 146, microcontroller 40 complements the Nth register. In step 148, the microcontroller verifies that Nth register now contains the bit pattern 10101010, equivalent to the hexadecimal value 0xAA. This demonstrates the 1-to-0 transitions of the even-numbered bits (counting right to left), and the 0-to-1 transitions of the odd-numbered bits for the Nth general purpose register. In step 148, microcontroller 40 also verifies that all the other general purpose registers other than the Nth register still contain the hexadecimal value 0x55. This assures that the complementing of the Nth general purpose register has no affect on the other general purpose registers. An appropriate verification method is discussed in detail below with reference to FIG. 12.

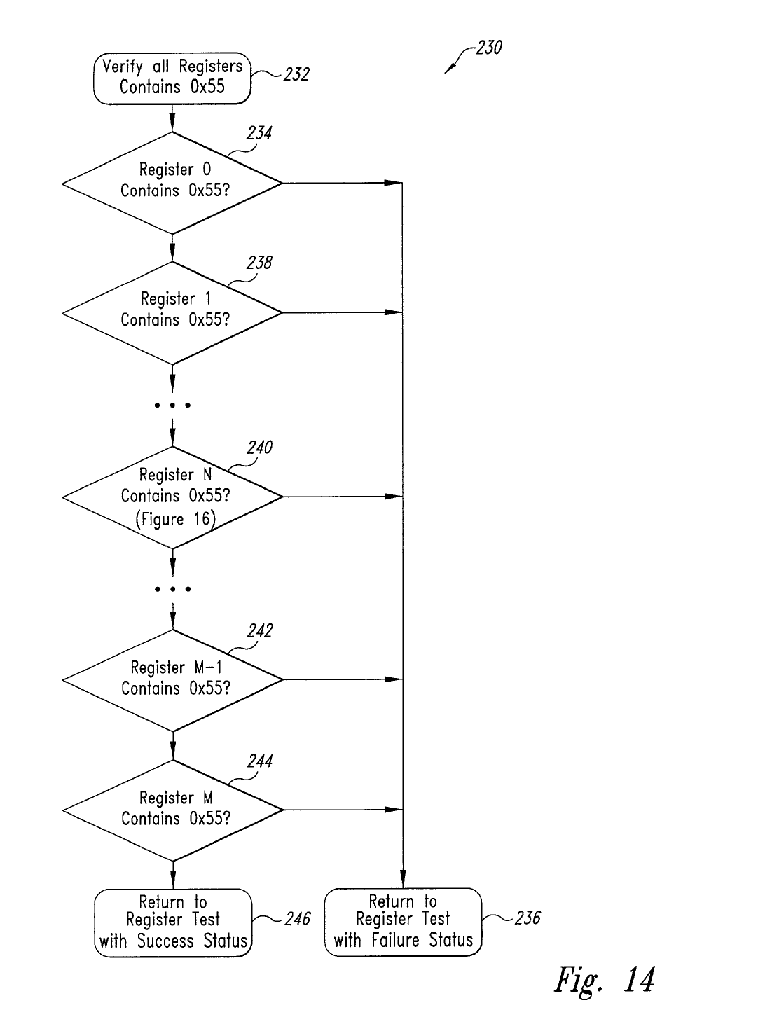

In step 150, microcontroller 40 determines if the verification of step 148 was true. If the verification was not true, microcontroller 40 returns to the calling register test method 110 with a failure status. If the verification is true, microcontroller 40 again complements the Nth general purpose register in step 154. In step 156, microcontroller 40 verifies that all registers now contain the hexadecimal value 0x55. This demonstrates the 0-to-1 transitions for the even number bits and the 1-to-0 transitions of the odd-numbered bits for the Nth general purpose register. This also assures that the complementing of the Nth general purpose register does not affect the other general purpose registers. A suitable routine for verifying that all registers contain the hexadecimal value 0x55 is described below with reference to FIG. 14.

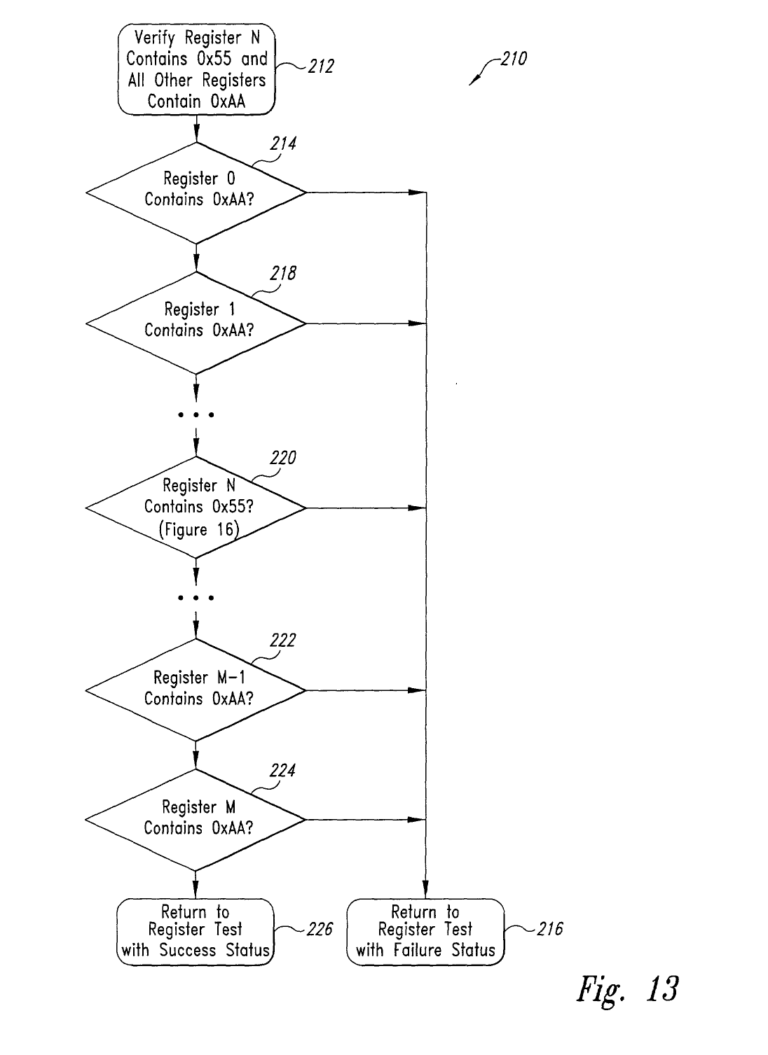

In step 158, microcontroller 40 determines if the verification of step 156 is true, returning to the calling register test method 110 with a failure status in step 160 if the verification is not true. If the verification is true, microcontroller 40 fills all of the general purpose registers with the hexadecimal value 0xAA, corresponding to the bit pattern 10101010 in step 162. In step 164, microcontroller 40 complements the Nth general purpose register. Continuing in reference to FIG. 11B, in step 166, microcontroller 40 verifies that the Nth general purpose register contains the hexadecimal value 0x55, and that all other general purpose registers still contain the hexadecimal value 0xAA. This demonstrates the 1-to-0 transitions of the odd-numbered bits and the 0-to-1 transitions of the even-numbered bits of the Nth general purpose register. This also assures that the complement of the Nth general purpose register does not affect the other general purpose registers. A suitable routine for performing step 166 is discussed below with reference to FIG. 13.

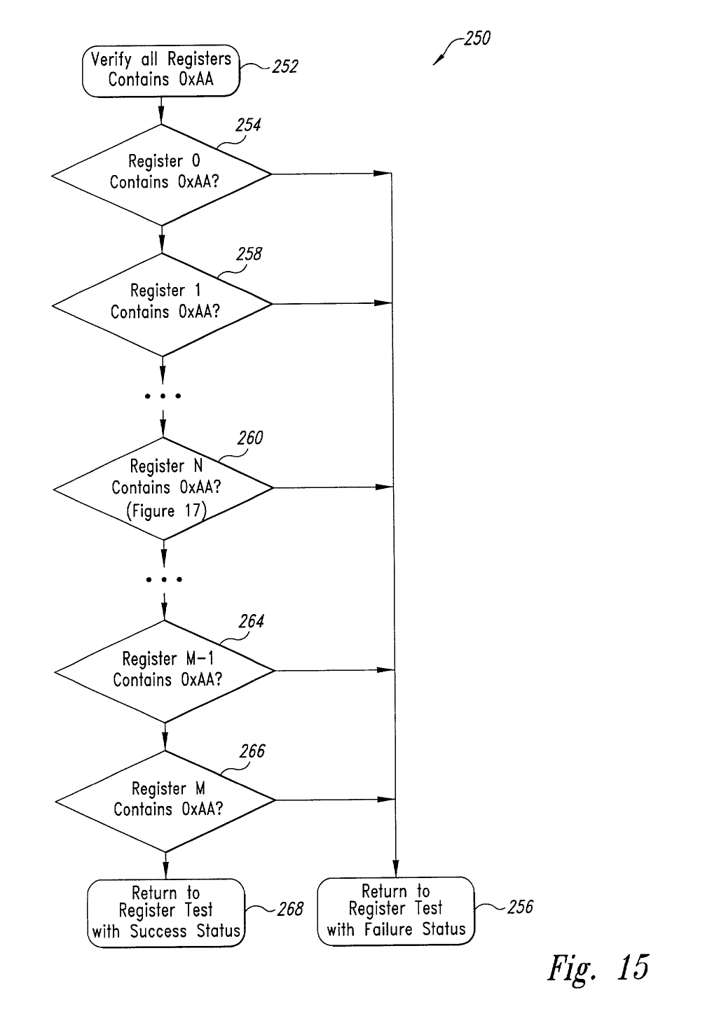

In step 168, microcontroller 40 determines if the verification step 166 is true, returning to the calling register test method 110 in step 170 with a failure status if the verification is not true. If the verification is true, microcontroller 40 again complements the Nth general purpose register, in step 172. In step 174, microcontroller 40 verifies that all general purpose registers now contain the hexadecimal value 0xAA. This demonstrates the 0-to-1 transitions of the odd-numbered bits and the 1-to-0 transitions of the even-numbered bits of the Nth general purpose register. This also assures that the complement of the Nth general purpose register does not affect the other general purpose registers. A suitable routine for performing step 174 is discussed in detail below with reference to FIG. 15.

In step 176, microcontroller 40 determines if the verification in step 174 is true. If the verification is not true, microcontroller 40 returns to the calling register test method 110 with a failure status in step 178. If the verification is true, microcontroller 40 returns to the calling register test method 110 with a success status in step 180.

FIG. 12 shows a method 190 of verifying that an Nth general purpose register contains the hexadecimal value 0xAA, and that all other general purpose registers contain the hexadecimal value 0x55. Microcontroller 40 can execute the method 190 as step 148 of the test register N method 140 (FIG. 11). The verifying method 190 starts in step 192, and is illustrated with the value of N between the first two and the last two general purpose registers.

In step 194, microcontroller 40 determines if the 0th general purpose register contains the hexadecimal value 0x55. In step 196, microcontroller 40 returns to the calling register test calling method 110 with a failure status if the 0th general purpose register does not contain the hexadecimal value 0x55. If the 0th general purpose register does contain hexadecimal value 0x55, microcontroller 40 passes control to step 198. In step 198, microcontroller 40 determines whether the 1st general purpose register contains hexadecimal value 0x55. If the 1st general purpose register does not contain the hexadecimal value 0x55, microcontroller 40 passes control to step 196. If 1st general purpose register does contain the hexadecimal value 0x55, microcontroller 40 passes control to test the next general purpose register. This continues until microcontroller 40 tests the Nth general purpose register in step 200.

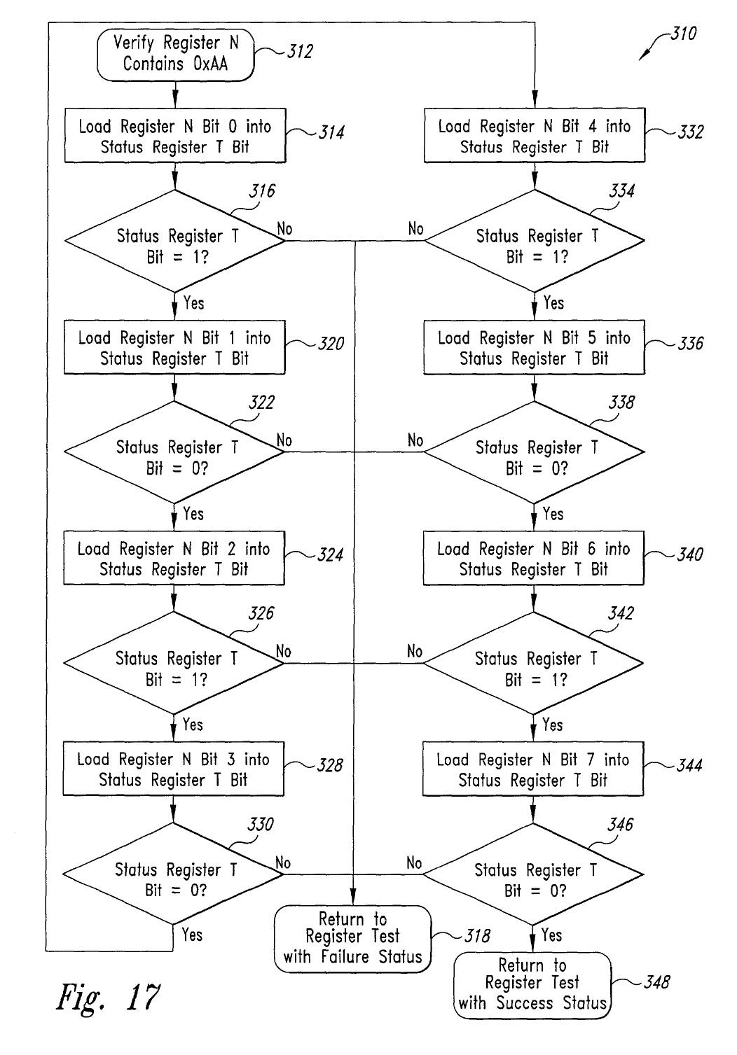

In step 200, microcontroller 40 determines whether Nth general purpose register contains the hexadecimal value 0xAA. A suitable method for performing step 200 is discussed in detail below with reference to FIG. 17. If microcontroller 40 determines that the Nth general purpose register does not contain the hexadecimal value 0xAA, microcontroller 40 passes control to step 196. Otherwise, microcontroller 40 continues to sequentially test the next general purpose registers, for example as shown in steps 202 and 204. If at the end of the verification method 190, the Nth general purpose register contains the hexadecimal value 0xAA and all other registers contain the hexadecimal value 0x55, microcontroller 40 returns to the calling register test method 110 with a success status condition in step 206.

FIG. 13 shows a method 210 verifying that an Nth general purpose register contains a hexadecimal value 0x55, and that all other general purpose registers contain the hexadecimal value 0xAA. Microcontroller 40 can execute the method 210 as step 166 of the test register N method 140 (FIG. 11). The verifying method 210 starts in step 212, and is illustrated with the value of N between the first two and the last two general purpose registers.

In step 214, microcontroller 40 determines if the 0th general purpose register contains hexadecimal value 0xAA. In step 216, microcontroller 40 returns to the calling register test method 110 with a failure status if the 0th general purpose register does not contain the hexadecimal value 0xAA. If the 0th general purpose register does contain the hexadecimal value 0xAA, microcontroller 40 passes control to step 218. In step 218, microcontroller 40 determines whether the 1st general purpose register contains the hexadecimal value 0xAA. If the 1st general purpose register does not contain the hexadecimal value 0xAA, microcontroller 40 passes control to step 216. If the 1st general purpose register does contain the hexadecimal value 0xAA, microcontroller 40 passes control to test the next general purpose register. This continues until microcontroller 40 tests the Nth general purpose register in step 220.

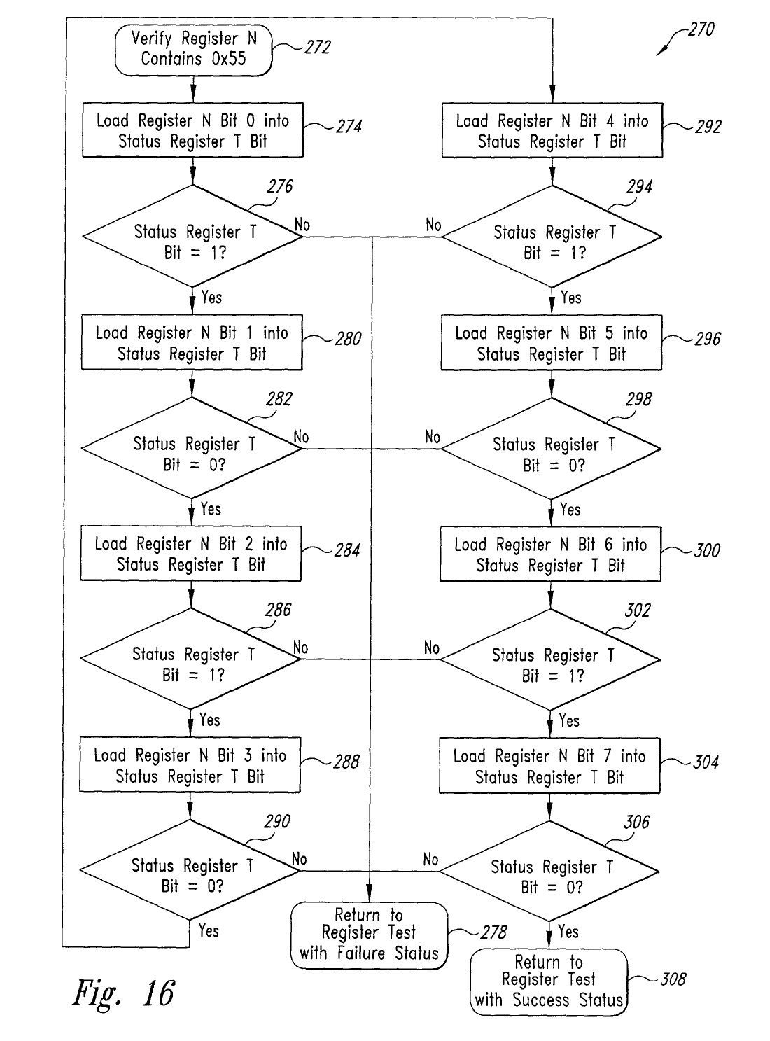

In step 220, microcontroller 40 determines whether the Nth general purpose register contains the hexadecimal value 0x55. A suitable method for performing step 220 is discussed in detail below with reference to FIG. 16. If microcontroller 40 determines that the Nth general purpose register does not contain the hexadecimal value 0x55, microcontroller 40 passes control to step 216. Otherwise the microcontroller continues to sequentially test the next general purpose registers, for example as shown in steps 222 and 224. If at the end of the verification method 210, the Nth general purpose register contains the hexadecimal value 0x55 and that all other general purpose registers contain the hexadecimal value 0xAA, microcontroller 40 returns to the calling register test method 110 with the success status condition in step 226.

FIG. 14 shows a method 230 of verifying that all general purpose registers contain the hexadecimal value 0x55. Microcontroller 40 can execute the method 230 as step 156 of the test register N method 140 (FIG. 11).

The method 230 starts in step 232. In step 234, microcontroller 40 determines whether the 0th general purpose register contains the hexadecimal value 0x55. If the 0th general purpose register does not contain the hexadecimal value 0x55, microcontroller 40 returns to the calling register test method 110 with a failure status in step 236. If the 0th general purpose register does contain the hexadecimal value 0x55, microcontroller 40 passes control to step 238 to determine whether the 1st general purpose register contains the hexadecimal value 0x55. Microcontroller 40 successively tests general purpose registers until the Nth general purpose register.

In step 240, microcontroller 40 determines whether the Nth general purpose register contains hexadecimal value 0x55. A suitable method for performing step 240 is discussed in detail below with reference to FIG. 16. If microcontroller 40 determines that the Nth general purpose register does not contain the hexadecimal value 0x55, microcontroller 40 returns to the calling register test method 110 with a failure status in step 236. Otherwise, microcontroller 40 continues testing successive general purpose registers, such as shown in steps 242 and 244. If at the end of the method 230 microcontroller 40 determines that all of the general purpose registers contain the hexadecimal value 0x55, microcontroller 40 returns to the calling register test method 110 with a success status in step 246.

FIG. 15 shows a method 250 of verifying that all general purpose registers contain the hexadecimal value 0xAA. Microcontroller 40 can execute the method 250 as step 174 of the test register N method 140 (FIG. 11).

The method 250 starts in step 252. In step 254, microcontroller 40 determines whether the 0th general purpose register contains hexadecimal value 0xAA. If the 0th general purpose register does not contain the hexadecimal value 0xAA, microcontroller 40 returns to the calling register test method 110 with a failure status in step 256. If the 0th general purpose register does contain the hexadecimal value 0xAA, microcontroller 40 passes control to step 258 to determine whether the 1st general purpose register contains hexadecimal value 0xAA. Microcontroller 40 successively tests general purpose registers until the Nth general purpose register.

In step 260, microcontroller 40 determines whether the Nth general purpose register contains the hexadecimal value 0xAA. A suitable method for performing step 260 is discussed in detail below with reference to FIG. 17. If microcontroller 40 determines that the Nth general purpose register does not contain the hexadecimal value 0xAA, microcontroller 40 returns to the calling register test method 110 with a failure state in step 256. Otherwise, microcontroller 40 continues testing successive general purpose registers, such as shown in steps 264 and 266. If at the end of the method 250 microcontroller 40 determines that all of the general purpose registers contain the hexadecimal value 0xAA, microcontroller 40 returns to the calling register test method 110 with a success status in step 268.

FIG. 16 shows a method 270 of verifying that an Nth general purpose register contains the hexadecimal value 0x55. Microcontroller 40 can execute the method 270 as step 220 of the verification method 210 (FIG. 13) and/or as step 240 of the verification method 230 (FIG. 14).

The method 270 starts in step 272. In step 274, microcontroller 40 loads the 0th bit of the Nth register into the T bit of the special purpose register, such as the status register R. The Status Register T bit (Test bit) of the Atmega103 microcontroller is used in the current implementation of the algorithm. The Atmega103 instruction set includes an instruction that conveniently supports the transfer of a specified bit in a specified general register to the Status Register T bit and an instruction that test the state of the T bit and then branches program control based on the tested state. More generally, any method of setting a bit in the Condition/Status Register of any microcontroller could be used as long as the processor has instructions that support the required transfer and test-and-branch instructions.

In step 276, microcontroller 40 determines if the T bit of the special purpose register is equal to 1 or HIGH. If the T bit of the special purpose register is not equal to 1 or HIGH, microcontroller 40 passes control to step 278, returning to the calling register test method 110 with a failure status. If the T bit of the special purpose register is equal to 1 or HIGH, microcontroller 40 passes control to step 280.

In step 280, microcontroller 40 loads the 1st bit of the Nth register into the T bit of the special purpose. In step 282, microcontroller 40 determines if the T bit of the special purpose register is equal to 0 or LOW. If the T bit of the special purpose register is not equal to 0 or LOW, microcontroller 40 passes control to step 278, returning to the calling register test method 110 with a failure status. If the T bit of the special purpose register is equal to 0 or LOW, microcontroller 40 passes control to step 284.

In step 284, microcontroller 40 loads the 2nd bit of the Nth general purpose register into the T bit of the special purpose register. In step 286, microcontroller 40 determines whether the T bit of the special purpose register is equal to 1 or HIGH. If the T bit of the special purpose register is not equal to 1 or HIGH, microcontroller 40 passes control to step 278, returning to the calling register test method 110 with a failure status. If the T bit of the status registers is equal to 1 or HIGH, the microcontroller passes control to step 288.

In step 288, microcontroller 40 loads the 3rd bit of the Nth general purpose register into the T bit of the special purpose register. In step 290, microcontroller 40 determines whether the T bit of the special purpose register is equal to 0 or LOW. If the T bit of the special purpose register is not equal to 0 or LOW, microcontroller 40 passes control to step 278, returning to the calling register test method 110 with a failure status. If the T bit of the special purpose register is equal to 0 or LOW, microcontroller 40 passes control to step 292.

In step 292, microcontroller 40 loads the 4th bit of the Nth general purpose register N into the T bit of the special purpose register. In step 294, the microcontroller 40 determines whether the T bit of the special purpose register is equal to 1 or HIGH. If the T bit of the special purpose register is not equal to 1 or HIGH, microcontroller 40 passes control to step 278, returning to the calling register test method 110 with a failure status. If the T bit of the special purpose register is equal to 1 or HIGH, microcontroller 40 passes control to step 296.

In step 296, microcontroller 40 loads the 5th bit of the Nth general purpose register into the T bit of the special purpose register. In step 298, the microcontroller 40 determines whether the T bit of the special purpose register is equal to 0 or LOW. If the T bit of the special purpose register is equal to 0 or LOW, microcontroller 40 passes control to step 278, returning to the calling register test method 110 with a failure status. If the T bit of the special purpose register is not equal to 0 or LOW, microcontroller 40 passes control to step 300.

In step 300, microcontroller 40 loads the 6th bit of the Nth general purpose register into the T bit of the special purpose register. In step 302, the microcontroller 40 determines whether the T bit of the special purpose register is equal to 1 or HIGH. If the T bit of the special purpose register is not equal to 1 or HIGH, microcontroller 40 passes control to step 278, returning to the calling register test method 110 with a failure status. If the T bit of the special purpose register is equal to 1 or HIGH, microcontroller 40 passes control to step 304.

In step 304, microcontroller 40 loads the 7th bit of the Nth general purpose register into the T bit of the special purpose register. In step 306, microcontroller 40 determines if the T bit of the special purpose register is equal to 0 or LOW. If the T bit of the special purpose register is not equal to 0 or LOW, microcontroller 40 passes control to step 278, returning to the calling test register method 110 with a failure status. If the T bit of the special purpose register is equal to 0 or LOW, microcontroller 40 passes control to step 308.

In step 308, microcontroller 40 returns to the register test calling routine 110 (FIG. 10) with a success status, indicating that the Nth general purpose register contains hexadecimal value 0x55.

FIG. 17 shows a method 310 of verifying that an Nth general purpose register contains the hexadecimal value 0xAA. Microcontroller 40 can execute the method 310 as step 200 of the verification method 190 (FIG. 12) and/or as step 260 of the verification method 250 (FIG. 15).

The method 310 starts in step 312. In step 314, microcontroller 40 loads the 0th bit of the Nth register into the T bit of the special purpose register, such as the status register R. In step 316, microcontroller 40 determines if the T bit of the special purpose register is equal to 0 or LOW. If the T bit of the special purpose register is not equal to 0 or LOW, microcontroller 40 passes control to step 318, returning to the calling register test method 110 with a failure status. If the T bit of the special purpose register is equal to 0 or LOW, microcontroller 40 passes control to step 320.

In step 320, microcontroller 40 loads the 1st bit of the Nth register into the T bit of the special purpose. In step 322, microcontroller 40 determines if the T bit of the special purpose register is equal to 1 or HIGH. If the T bit of the special purpose register is not equal to 1 or HIGH, microcontroller 40 passes control to step 318, returning to the calling register test method 110 with a failure status. If the T bit of the special purpose register is equal to 1 or HIGH, microcontroller 40 passes control to step 324.

In step 324, microcontroller 40 loads the 2nd bit of the Nth general purpose register into the T bit of the special purpose register. In step 326, microcontroller 40 determines whether the T bit of the special purpose register is equal to 0 or LOW. If the T bit of the special purpose register is not equal to 0 or LOW, microcontroller 40 passes control to step 318, returning to the calling register test method 110 with a failure status. If the T bit of the status registers is equal to 0 or LOW, the microcontroller passes control to step 328.

In step 328, microcontroller 40 loads the 3rd bit of the Nth general purpose register into the T bit of the special purpose register. In step 330, microcontroller 40 determines whether the T bit of the special purpose register is equal to 1 or HIGH. If the T bit of the special purpose register is not equal to 1 or HIGH, microcontroller 40 passes control to step 318, returning to the calling register test method 110 with a failure status. If the T bit of the special purpose register is equal to 1 or HIGH, microcontroller 40 passes control to step 332.

In step 332, microcontroller 40 loads the 4th bit of the Nth general purpose register N into the T bit of the special purpose register. In step 334, microcontroller 40 determines whether the T bit of the special purpose register is equal to 0 or LOW. If the T bit of the special purpose register is not equal to 0 or LOW, microcontroller 40 passes control to step 318, returning to the calling register test method 110 with a failure status. If the T bit of the special purpose register is equal to 0 or LOW, microcontroller 40 passes control to step 336.

In step 336, microcontroller 40 loads the 5th bit of the Nth general purpose register into the T bit of the special purpose register. In step 338, microcontroller 40 determines whether the T bit of the special purpose register is equal to 1 or HIGH. If the T bit of the special purpose register is not equal to 1 or HIGH, microcontroller 40 passes control to step 318, returning to the calling register test method 110 with a failure status. If the T bit of the special purpose register is not equal to 1 or HIGH, microcontroller 40 passes control to step 340.

In step 340, microcontroller 40 loads the 6th bit of the Nth general purpose register into the T bit of the special purpose register. In step 342, microcontroller 40 determines whether the T bit of the special purpose register is equal to 0 or LOW. If the T bit of the special purpose register is not equal to 0 or LOW, microcontroller 40 passes control to step 318, returning to the calling register test method 110 with a failure status. If the T bit of the special purpose register is equal to 0 or LOW, microcontroller 40 passes control to step 344.

In step 344, microcontroller 40 loads the 7th bit of the Nth general purpose register into the T bit of the special purpose register. In step 346, microcontroller 40 determines if the T bit of the special purpose register is equal to 1 or HIGH. If the T bit of the special purpose register is not equal to 1 or HIGH, microcontroller 40 passes control to step 318, returning to the calling test register method 110 with a failure status. If the T bit of the special purpose register is equal to 1 or HIGH, microcontroller 40 passes control to step 348.

In step 348, microcontroller 40 returns to the register test calling routine 110 (FIG. 10) with a success status, indicating that the Nth general purpose register contains hexadecimal value 0xAA.

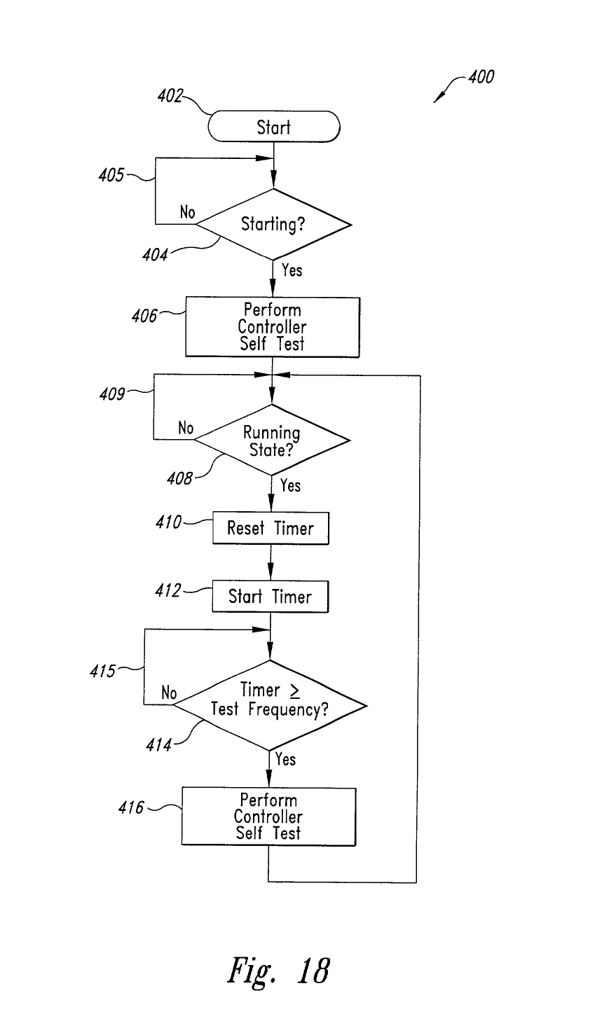

FIG. 18 shows a method 400 of performing a microcontroller self-check in relationship to an operational state of the fuel cell system, according to the methods set out in FIGS. 9-19, in relationship to an operational state of the fuel cell system, starting in step 402.

In step 404, microcontroller 40 determines if fuel cell system 10 is in a starting state, executing a wait loop 405 if fuel cell system 10 is not in a starting state. If fuel cell system 10 is in a starting state, microcontroller 40 performs a self test, for example, according to the methods of FIGS. 9-19.

While illustrated for only starting and running states, microcontroller 40 may perform a portion or all of the self test of the general registers in some or all of the operational states, not just starting and running states. For example, microcontroller 40 can perform the self test algorithm in all operational states, including a standby state. A self test suite may include various components in addition to the self test of the general registers. Microcontroller 40 may execute an entire self test suite sequentially and continually while power is supplied to fuel cell system 10.

In one embodiment, the self test of the general registers can be composed of 64 distinct tests, 2 tests (i.e., x055, x0AA) for each of the 32 general purpose registers of the Atmega103. Four invocations of the routine for self testing of the general purpose registers are made during each 1 second execution of the scheduling algorithm (discussed above). Thus, microcontroller 40 requires approximately 16 total seconds test of all of the general purpose registers. Where a self test suite includes additional tests beyond the tests of the general purpose registers, the self test suite may take between 3 and 4 minutes to complete. Thus, microcontroller 40 may not be able to complete a self test of all of the general purpose registers during any one operational state, particularly where the operational state is short such as a starting state which typically lasts less than 15 seconds.

In step 406, microcontroller 40 determines if fuel cell system 10 is in a running state, executing a wait loop 409 if fuel cell system 10 is not in a running state. If fuel cell system 10 is in a running state, microcontroller 40 resets a timer in step 410 and starts the timer in step 412. In step 414, microcontroller 40 determines if the timer is greater than or equal to the microcontroller's self-test frequency, such as the self-test frequency set out in commonly assigned U.S. patent application Ser. No. ______, entitled FUEL CELL SYSTEM METHOD, APPARATUS AND SCHEDULING (Atty. Docket No. 130109.409). If the timer is not greater than or equal to the self-test frequency, microcontroller 40 executes a wait loop 415. If the timer is not greater than or equal to the self-test frequency, microcontroller 40 performs a self test, for example, according to the methods of FIGS. 9-19. Microcontroller 40 then passes control back to step 408, to periodically repeat the self-test while fuel cell system 10 is in a running state.

Although specific embodiments, and examples for, the invention are described herein for illustrative purposes, various equivalent modifications can be made without departing from the spirit and scope of the invention, as will be recognized by those skilled in the relevant art. The teachings provided herein of the invention can be applied to other fuel cell systems, not necessarily the polymer electrolyte membrane fuel cell system described above. The teachings can also be applied to other processor controlled systems, not necessarily the fuel cell systems generally described above.

Commonly assigned U.S. patent application Ser. No. ______, entitled FUEL CELL AMBIENT ENVIRONMENT MONITORING AND CONTROL APPARATUS AND METHOD (Atty. Docket No. 130109.404); Ser. No. ______, entitled FUEL CELL ANOMALY DETECTION METHOD AND APPARATUS (Atty. Docket No. 130109.406); Ser. No. ______, entitled FUEL CELL PURGING METHOD AND APPARATUS (Atty. Docket No. 130109.407); Ser. No. ______, entitled FUEL CELL RESUSCITATION METHOD AND APPARATUS (Atty. Docket No. 130109.408); Ser. No. ______, entitled FUEL CELL SYSTEM METHOD, APPARATUS AND SCHEDULING (Atty. Docket No. 130109.409); Ser. No. ______, entitled FUEL CELL SYSTEM AUTOMATIC POWER SWITCHING METHOD AND APPARATUS (Atty. Docket No. 130109.421); Ser. No. ______, entitled PRODUCT WATER PUMP FOR FUEL CELL SYSTEM (Atty. Docket No. 130109.427); and Ser. No. ______, entitled FUEL CELL SYSTEM HAVING A HYDROGEN SENSOR (Atty. Docket No. 130109.429), all filed Jul. 25, 2001, are incorporated herein by reference, in their entirety.

The various embodiments described above and in the applications and patents incorporated herein by reference can be combined to provide further embodiments. The described methods can omit some acts and can add other acts, and can execute the acts in a different order than that illustrated, to achieve the advantages of the invention.

These and other changes can be made to the invention in light of the above detailed description. In general, in the following claims, the terms used should not be construed to limit the invention to the specific embodiments disclosed in the specification, but should be construed to include all fuel cell systems, controllers and processors, actuators, and sensors that operate in accordance with the claims. Accordingly, the invention is not limited by the disclosure, but instead its scope is to be determined entirely by the following claims.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A fuel cell system, comprising:
a fuel cell stack;
at least one sensor proximate the fuel cell stack to detect an operating parameter of the fuel cell stack;
at least one actuator; and
a microcontroller coupled to receive signals from the sensor and to provide signals to the actuator and configured to perform a self test by:
setting a set of bits in a number of general registers of the microcontroller to a predefined pattern;
complementing the set of bits of one of the general registers;
copying the set of bits from the one of the general registers to a special register of the microcontroller;
determining if each bit in the set of bits copied to the special register was complemented; and
producing a notification signal based on the determination.

2. The fuel cell system of claim 1 wherein the microcontroller is further configured to perform at least a portion of the self test at least once while the fuel cell system is in a starting state prior to operation of the fuel cell system and at least once while the fuel cell system is in a running state during operation of the fuel cell system.

3. The fuel cell system of claim 1 wherein the microcontroller is further configured to perform the self test by:
for each general register other than the one of the general registers,
copying the set of bits from the other general register to the special register;
determining if each bit in the set of bits copied to the special register from the other general register matches the corresponding bit in the predefined pattern; and
producing a notification signal based on the determination.

4. The fuel cell system of claim 1 wherein the microcontroller is further configured to perform the self test by:
for each general register other than the one of the general registers,
copying the set of bits from the other general register to the special register; and
determining if each bit in the set of bits copied to the special register from the other general register matches the corresponding bit in the predefined pattern;
complementing the previously complemented set of bits in the one of the general registers;
copying the set of bits from the one of the general registers to the special register of the microcontroller;
determining if each bit in the set of bits copied to the special register from the one of the general registers matches the predefined pattern; and
producing a notification signal based on the determinations.

5. The fuel cell system of claim 1 wherein the microcontroller is further configured to perform the self test by:
for each general register other than the one of the general registers,
copying the set of bits from the other general register to the special register; and
determining if each bit in the sets of bits copied to the special register from the other general register matches the corresponding bit in the predefined pattern;
complementing the previously complemented set of bits in the one of the general registers;
copying the set of bits from the one of the general registers to the special register of the microcontroller;
determining if each bit in the set of bits copied to the special register from the one of the general registers matches the predefined pattern;
for each of the other of the general registers, copying the set of bits from the other general register to the special register; and
determining if each bit in the set of bits copied to the special register from the other general register matches the corresponding bit in the predefined pattern; and
producing a notification signal based on the determinations.

6. The fuel cell system of claim 1 wherein the predefined pattern alternates the setting of each next successive bit.

7. The fuel cell system of claim 1, further comprising:
successively repeating the acts of claims 1 and 5 for each of the general registers as the one of the general register.

8. A controller for controlling an operation of a fuel cell system, the controller configured to:
set a set of bits in a number of general registers of the controller to a predefined pattern;
complement the set of bits of one of the general registers;
copy the set of bits from the one of the general registers to a special register of the controller; and
determine if each bit in the set of bits copied to the special register was complemented.

9. The controller of claim 8, further configured to:
for each of the other of the general registers, copy the set of bits from the other general register to the special register;
determine if each bit in the sets of bits copied to the special register from the other general registers matches the corresponding bit in the predefined pattern; and
produce a notification signal based on the determination.

10. The controller of claim 8, further configured to:
for each of the other of the general registers, copy the set of bits from the other general register to the special register;
determine if each bit in the sets of bits copied to the special register from the other general registers matches the corresponding bit in the predefined pattern;
complement the previously complemented set of bits in the one of the general registers;
copy the set of bits from the one of the general registers to the special register of the controller;
determine if each bit in the set of bits copied to the special register matches the predefined pattern; and
produce a notification signal based on the determinations.

11. The controller of claim 8, further configured to:
for each of the other of the general registers, copy the set of bits from the other general register to the special register;
determine if each bit in the sets of bits copied to the special register from the other general registers matches the corresponding bit in the predefined pattern;
complement the previously complemented set of bits in the one of the general registers;
copy the set of bits from the one of the general registers to the special register of the controller;
determine if each bit in the set of bits copied to the special register matches the predefined pattern;
for each of the other of the general registers, copy the set of bits from the other general register to the special register;
determine if each bit in the sets of bits copied to the special register from the other general registers matches the corresponding bit in the predefined pattern; and
producing a notification signal based on the determinations.

12. A controller for controlling an operation of a fuel cell system, the controller configured to:
perform at least a portion of one self test of the general registers of the controller while the fuel cell system is in a starting state prior to operation of the fuel cell system; and
perform at least a portion of one self test of the general registers of the controller while the fuel cell system is in a running state during operation of the fuel cell system.

13. The controller of claim 12 wherein the controller is configured to perform the self test by:
setting a set of bits in a number of general registers of the controller to a predefined pattern;
complementing the set of bits of one of the general registers;
copying the set of bits from the one of the general registers to a special register of the controller; and
determining if each bit in the set of bits copied to the special register was complemented.

14. The controller of claim 12 wherein the controller is configured to perform the self test by:
setting a set of bits in a number of general registers of the controller to a predefined pattern;
complementing the set of bits of one of the general registers;
copying the set of bits from the one of the general registers to a special register of the controller;
determining if each bit in the set of bits copied to the special register was complemented;
for each of the other of the general registers, copying the set of bits from the other of the general register to the special register;
determining if each bit in the sets of bits of the copied to the special register from the other general registers matches the corresponding bit in the predefined pattern;
complementing the set of bits in the one of the general registers;
copying the set of bits from the one of the general registers to the special register of the controller;
determining if each bit in the set of bits copied to the special register matches the predefined pattern;
for each of the other of the general registers, copying the set of bits from the other of general register to the special register;
determining if each bit in the sets of bits of the copied to the special register from the other general registers matches the corresponding bit in the predefined pattern; and
producing a notification signal based on the determination

15. A controller readable memory carrying instructions for causing a controller to perform a self test, by:
setting a set of bits in a number of general registers of the controller to a predefined pattern;
complementing the set of bits of one of the general registers;
copying the set of bits from the one of the general registers to a special register of the controller; and
determining if each bit in the set of bits copied to the special register was complemented.

16. The controller readable memory of claim 15 carrying instructions for causing the controller to perform the self test, further by:
for each of the other of the general registers, copying the set of bits from the other general register to the special register;
determining if each bit in the sets of bits copied to the special register from the other general registers matches the corresponding bit in the predefined pattern; and
producing a notification based on the determination.

17. The controller readable memory of claim 15 carrying instructions for causing the controller to perform the self test, further by:
for each of the other of the general registers, copying the set of bits from the other general register to the special register;
determining if each bit in the sets of bits copied to the special register from the other general registers matches the corresponding bit in the predefined pattern;
complementing the previously complemented set of bits in the one of the general registers;
copying the set of bits from the one of the general registers to the special register of the controller;
determining if each bit in the set of bits copied to the special register from the one of the general registers matches the predefined pattern; and
producing a notification based on the determinations.

18. The controller readable memory of claim 15 carrying instructions for causing the controller to perform the self test, further by:
for each of the other of the general registers, copying the set of bits from the other general register to the special register;
determining if each bit in the sets of bits copied to the special register from the other general registers matches the corresponding bit in the predefined pattern;
complementing the previously complemented set of bits in the one of the general registers;
copying the set of bits from the one of the general registers to the special register of the controller;
determining if each bit in the set of bits copied to the special register from the one of the general registers matches the predefined pattern;
for each of the other of the general registers, copying the set of bits from the other general register to the special register;
determining if each bit in the sets of bits copied to the special register from the other general registers matches the corresponding bit in the predefined pattern; and
producing a notification based on the determinations.

19. A controller readable memory carrying instructions for causing a controller to:
perform at least a portion of one self test of the controller while the fuel cell system is in a starting state prior to operation of the fuel cell system; and
perform at least a portion of one self test of the controller while the fuel cell system is in a running state during operation of the fuel cell system.

20. The controller readable memory of claim 19 wherein the instructions cause the controller to perform the self test, by:
setting a set of bits in a number of general registers of the controller to a predefined pattern;
complementing the set of bits of one of the general registers;
copying the set of bits from the one of the general registers to a special register of the controller; and
determining if each bit in the set of bits copied to the special register was complemented.

21. The controller readable memory of claim 19 wherein the instructions cause the controller to perform the self test, by:
setting a set of bits in a number of general registers of the controller to a predefined pattern;
complementing the set of bits of one of the general registers;
copying the set of bits from the one of the general registers to a special register of the controller;
determining if each bit in the set of bits copied to the special register was complemented;
for each of the other of the general registers, copying the set of bits from the other general register to the special register;
determining if each bit in the sets of bits of the copied to the special register from the other general registers matches the corresponding bit in the predefined pattern;
complementing the previously complemented set of bits in the one of the general registers;
copying the set of bits from the one of the general registers to the special register of the controller;
determining if each bit in the set of bits copied to the special register from the one of the general registers matches the predefined pattern;
for each of the other of the general registers, copying the set of bits from the other general register to the special register;
determining if each bit in the sets of bits copied to the special register from the other general registers matches the corresponding bit in the predefined pattern; and
producing a notification signal based on the determination.

22. A method of operating a controller in a fuel cell system, comprising:
setting a set of bits in each of a number of general purpose registers of the controller to a predefined pattern;
successively, for each of the general propose registers of the controller, complementing the set of bits of the general purpose register;
copying the set of bits from the general purpose register to a special purpose register of the controller; and
determining if the bits copied to the special purpose register are complemented with respect to the predefined pattern.

23. The method of claim 22 wherein the predefined value alternates the value of adjacent bits in the set of bits.

24. The method of claim 22, further comprising:
for each of general purpose registers of the controller,
complementing the complemented set of bits of the general purpose register;
copying the set of bits from the general purpose register to the special purpose register of the controller; and
determining if bits copied to the special purpose register match the predefined pattern.

25. The method of claim 22, further comprising:
successively following each of the determining if the bits copied to the special purpose register are complemented with respect to the predefined pattern,
for each of the general purpose registers not having complemented bits,
copying the set of bits from the general purpose register to the special purpose register; and
determining if the bits copied to the special purpose register match the predefined pattern.

26. The method of claim 22 wherein the acts are performed while the fuel cell system is in a running state during operation of the fuel cell system.

27. The method of claim 22 wherein the acts are performed at least once while the fuel cell system is in a starting state prior to operation of the fuel cell system and at least once while the fuel cell system is in a running state during operation of the fuel cell system.

28. A method of operating a controller in a fuel cell system, comprising:
performing at least a portion of one self test of the controller while the fuel cell system is in a starting state prior to operation of the fuel cell system; and
performing at least a portion of one self test of the controller while the fuel cell system is in a running state during operation of the fuel cell system.

29. The method of claim 28 wherein performing a self test of the controller includes:
setting a set of bits in a number of general purpose registers of the controller to a predefined pattern;
complementing the set of bits of one of the general purpose registers;
copying the set of bits from the one of the general purpose registers to a special purpose register of the controller; and
determining if each bit in the set of bits copied to the special purpose register from the one of the general purpose registers was complemented.

30. The method of claim 28 wherein performing a self test of the controller includes:
setting a set of bits in a number of general purpose registers of the controller to a predefined pattern;
complementing the set of bits of one of the general purpose registers;
copying the set of bits from the one of the general purpose registers to a special purpose register of the controller;
determining if each bit in the set of bits copied to the special purpose register from the one of the general purpose registers was complemented;
for each of the other of the general purpose registers, copying the set of bits from the other general purpose register to the special purpose register;
determining if each bit in the sets of bits of the copied to the special purpose register from the other general purpose registers matches the corresponding bit in the predefined pattern; and
producing a notification signal based on the determination.

31. The method of claim 28 wherein performing a self test of the controller includes:
setting a set of bits in a number of general purpose registers of the controller to a predefined pattern;
complementing the set of bits of one of the general purpose registers;
copying the set of bits from the one of the general purpose registers to a special purpose register of the controller;
determining if each bit in the set of bits copied to the special purpose register from the one of the general purpose registers was complemented;
for each of the other of the general purpose registers, copying the set of bits from the other general purpose register to the special purpose register;
determining if each bit in the sets of bits of the copied to the special purpose register from the other general purpose registers matches the corresponding bit in the predefined pattern;
complementing the previously complemented set of bits in the one of the general purpose registers;
copying the set of bits from the one of the general purpose registers to the special purpose register of the controller;
determining if each bit in the set of bits copied to the special purpose register from the one of the general purpose registers matches the predefined pattern; and
producing a notification signal based on the determination.

32. The method of claim 28 wherein performing a self test of the controller includes:
setting a set of bits in a number of general purpose registers of the controller to a predefined pattern;
complementing the set of bits of one of the general purpose registers;
copying the set of bits from the one of the general purpose registers to a special purpose register of the controller;
determining if each bit in the set of bits copied to the special purpose register from the one of the general purpose registers was complemented;
for each of the other of the general purpose registers, copying the set of bits from the other general purpose register to the special purpose register;
determining if each bit in the sets of bits copied to the special purpose register from the other general purpose registers matches the corresponding bit in the predefined pattern;
complementing the previously complemented set of bits in the one of the general purpose registers;
copying the set of bits from the one of the general purpose registers to the special purpose register of the controller;
determining if each bit in the set of bits copied to the special purpose register from the one of the general purpose registers matches the predefined pattern;
for each of the other of the general purpose registers, copying the set of bits from the other general purpose register to the special purpose register;
determining if each bit in the sets of bits copied to the special purpose register from the other general purpose registers matches the corresponding bit in the predefined pattern; and
producing a notification signal based on the determination.
